(19) United States
(12) Patent Application Publication
(10) Pub. No.: US 2020/0361462 A1
(43) Pub. Date: Nov. 19, 2020

(54) VEHICLE CONTROL DEVICE, TERMINAL DEVICE, PARKING LOT MANAGEMENT DEVICE, VEHICLE CONTROL METHOD, AND STORAGE MEDIUM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/872,407

(22) Filed: May 12, 2020

(30) Foreign Application Priority Data
May 14, 2019 (JP) 2019-091348

(51) Int. Cl. B60W 30/14; B60W 10/20; G08G 1/14; G08G 1/00; B60W 30/09; B60W 30/095; G01C 21/36; G01C 21/34; B60W 60/00

(52) U.S. Cl. CPC B60W 30/143; B60W 10/20; G08G 1/14; G08G 1/22; B60W 60/0025; B60W 30/0956; G01C 21/3691; G01C 21/3407; B60W 30/09

(57) ABSTRACT

According to an embodiment, A vehicle control device includes: a processor; a memory storing program instructions executable by the processor to: recognize a surrounding environment of a host vehicle; and perform driving control of one or both of a speed and steering of the host vehicle on the basis of a recognition result of the recognizer, wherein performing driving control comprises storing a traveling trajectory until the host vehicle enters a parking place in a storage, generating a scheduled traveling route for leaving using the traveling trajectory when the host vehicle leaves the parking place, and causing the host vehicle to travel on the basis of the generated scheduled traveling route.

### CROSS-REFERENCE TO RELATED APPLICATION

Priority is claimed on Japanese Patent Application No. 2019-091348, filed May 14, 2019, the content of which is incorporated herein by reference.

### BACKGROUND

### Field of the Invention

The present invention relates to a vehicle control device, a terminal device, a parking lot management device, a vehicle control method, and a storage medium.

### Description of Related Art

In recent years, research has been conducted on automatedly controlling vehicles. In relation to this research, technology for communicating with a management device for managing a parking lot and performing entering or leaving according to guidance of the management device when a vehicle is moved within the parking lot is known (for example, Japanese Unexamined Patent Application, First Publication No. 2017-182230).

### SUMMARY

However, in the conventional technology, when a state of communication with the management device is not normal, driving control for entering or leaving may not be properly performed.

The present invention has been made in view of such circumstances and an objective of the present invention is to provide a vehicle control device, a terminal device, a parking lot management device, a vehicle control method, and a storage medium capable of executing more appropriate driving control in a situation in which a vehicle travels in an area including a parking lot.

A vehicle control device, a terminal device, a parking lot management device, a vehicle control method, and a storage medium according to the present invention adopt the following configurations.

(1): According to an aspect of the present invention, there is provided a vehicle control device including: a processor; a memory storing program instructions executable by the processor to: recognize a surrounding environment of a host vehicle; and perform driving control of one or both of a speed and steering of the host vehicle on the basis of a recognition result of the recognizer, wherein performing driving control comprises storing a traveling trajectory until the host vehicle enters a parking place in a storage, generating a scheduled traveling route for leaving using the traveling trajectory when the host vehicle leaves the parking place, and causing the host vehicle to travel on the basis of the generated scheduled traveling route.

(2): In the above-described aspect (1), the program instructions are further executable by the processor to: communicate with a terminal device and a parking lot management device for managing a parking lot including the parking place, wherein performing driving control comprises generating a traveling route for leaving using the traveling trajectory when communication with the parking lot management device is not normal or when receiving information indicating an abnormal state transmitted from the parking lot management device and a leaving instruction from the terminal device has been received and causing the host vehicle to travel on the basis of the generated traveling route.

(3): In the above-described aspect (1), generating the scheduled traveling route comprises generating a scheduled traveling route for causing the host vehicle to travel along the traveling trajectory in a reverse direction.

(4): In the above-described aspect (2), performing driving control comprises when another vehicle is present at a position where the host vehicle cannot travel along the scheduled traveling route, performing communication with the other vehicle and causing the other vehicle to move to a position where the host vehicle can travel along the scheduled traveling route.

(5): In the above-described aspect (2), performing driving control comprises acquiring a scheduled traveling route and an entering time of another vehicle whose leaving is in progress, comparing the entering time of the other vehicle with an entering time of the host vehicle when the acquired scheduled traveling route overlaps at least a part of the scheduled traveling route of the host vehicle, and causing the vehicle whose entering time is earlier to preferentially leave.

(6): In the above-described aspect (1), performing driving control comprises when a physical object at a position where the host vehicle cannot travel along the scheduled traveling route, generating an avoidance route along which the host vehicle will travel while avoiding contact with the physical object on the basis of the scheduled traveling route and causing the host vehicle to travel along the generated avoidance route.

(7): In the above-described aspect (2), performing driving control comprises when communication with the parking lot management device is not normal or when the processor has acquired information indicating an abnormal state transmitted from the parking lot management device, curbing driving control for entry to the parking place.

(8): There is provided a terminal device for communicating with the vehicle control device according to the above-described aspect (1), the terminal device including: a processor; a memory storing program instructions executable by the processor to: communicate with the vehicle control device and a parking lot management device for managing a parking lot including the parking place where vehicles are parked; and output an entering request or a leaving request of the host vehicle to the parking lot management device when a state of communication with the parking lot management device is normal and output a leaving request of the host vehicle to the vehicle control device when the state of communication with the parking lot management device is not normal or when the processor has acquired information indicating an abnormal state transmitted from the parking lot management device and communication with the vehicle control device is enabled.

(9): In the above-described aspect (8), outputting driving control comprises the entering request or the leaving request comprises doing not output the leaving request of the host vehicle to the vehicle control device when the state of communication with the parking lot management device is not normal or when the processor has acquired information indicating the abnormal state transmitted from the parking lot management device and the communication with the vehicle control device is normal.

(10): There is provided a parking lot management device for communicating with the vehicle control device according to the above-described aspect (1) and managing a parking lot including the parking place where vehicles are parked, the parking lot management device including: a processor; a memory storing program instructions executable by the processor to: communicate with the vehicle control device and a terminal device; and control entering or leaving of a vehicle for each parking place of the parking lot, wherein controlling entering or leaving of the vehicle comprises inquiring of a vehicle present in the parking lot about a parking situation when a state of communication with the vehicle control device and the terminal device has changed from an abnormal state to a normal state and managing the parking situation of the parking lot on the basis of an inquiry result.

(11): In the above-described aspect (10), controlling entering or leaving of the vehicle comprises curbing control of entering or leaving of another vehicle until the entering or leaving of the vehicle whose entering or leaving is in progress is completed when the vehicle whose entering or leaving is in progress is included in the inquiry result.

(12): According to an aspect of the present invention, there is provided a vehicle control method including: recognizing, by a computer, a surrounding environment of a host vehicle; performing, by the computer, driving control of one or both of a speed and steering of the host vehicle on the basis of a recognition result; storing, by the computer, a traveling trajectory until the host vehicle enters a parking place in a storage; generating, by the computer, a scheduled traveling route for leaving using the traveling trajectory when the host vehicle leaves the parking place; and causing, by the computer, the host vehicle to travel on the basis of the generated scheduled traveling route.

(13): According to an aspect of the present invention, there is provided a computer-readable non-transitory storage medium storing a program for causing a computer to: recognize a surrounding environment of a host vehicle; perform driving control of one or both of a speed and steering of the host vehicle on the basis of a recognition result; store a traveling trajectory until the host vehicle enters a parking place in a storage; generate a scheduled traveling route for leaving using the traveling trajectory when the host vehicle leaves the parking place; and cause the host vehicle to travel on the basis of the generated scheduled traveling route.

According to the above-described aspects (1) to (13), it is possible to execute more appropriate driving control in a situation in which a vehicle travels in an area including a parking lot.

### BRIEF DESCRIPTION OF THE DRAWINGS

FIG. 1 is a configuration diagram of a vehicle system including a vehicle control device according to an embodiment.

FIG. 2 is a functional configuration diagram of a first controller and a second controller.

FIG. 3 is a diagram showing an example of a functional configuration of a terminal device.

FIG. 4 is a diagram schematically showing a scene in which an autonomous parking event is executed in the embodiment.

FIG. 5 is a diagram showing an example of an image displayed as an automated entering acceptance screen on a display of a terminal device.

FIG. 6 is a diagram showing an example of an image for inputting a scheduled leaving time.

FIG. 7 is a diagram showing an example of a configuration of a parking lot management device.

FIG. 8 is a diagram for describing a traveling trajectory recognizer.

FIG. 9 is a diagram showing an example of an image displayed as an automated leaving acceptance screen on the display of the terminal device.

FIG. 10 is a diagram showing an example of an image indicating that an automated entering process cannot be executed.

FIG. 11 is a diagram showing an example of an image for inquiring about whether or not to directly issue a leaving instruction to a host vehicle.

FIG. 12 is a diagram for describing a process of generating a scheduled traveling route in a direction opposite to a direction of a vehicle when the vehicle has traveled along the traveling trajectory at the time of entering.

FIG. 13 is a diagram showing an example of a scene in which another vehicle is present on the scheduled traveling route.

FIG. 14 is a diagram showing a scene after another vehicle is moved.

FIG. 15 is a diagram for describing driving control when a scheduled traveling route of another vehicle is predicted to overlap a part of a scheduled traveling route of the host vehicle M.

FIG. 16 is a diagram for describing driving control when an obstacle is present on the scheduled traveling route.

FIG. 17 is a diagram for describing updating of a parking space state table.

FIG. 18 is a flowchart showing an example of a flow of a process to be executed by the terminal device of the embodiment.

FIG. 19 is a flowchart showing an example of a flow of an automated entering process to be executed by the automated driving controller of the embodiment.

FIG. 20 is a flowchart showing an example of a flow of an automated leaving process to be executed by the automated driving controller of the embodiment.

FIG. 21 is a flowchart showing an example of a flow of a process to be executed by a parking lot management device 500 after a communication state is restored.

FIG. 22 is a diagram showing an example of a hardware configuration of the automated driving controller according to the embodiment.

### DESCRIPTION OF EMBODIMENTS

Hereinafter, embodiments of a vehicle control device, a terminal device, a parking lot management device, a vehicle control method, and a storage medium of the present invention will be described with reference to the drawings. Hereinafter, an embodiment in which a vehicle control device is applied to an automated driving vehicle will be described as an example. The automated driving means, for example, automatedly controlling one or both of steering and acceleration/deceleration of the vehicle to execute the driving control. In the automated-driving vehicle, the driving control may be executed by a manual operation of an occupant. Although a case in which left-hand traffic regulations are applied will be described, it is only necessary to reverse the left and right when right-hand traffic regulations are applied.

### [Overall Configuration]

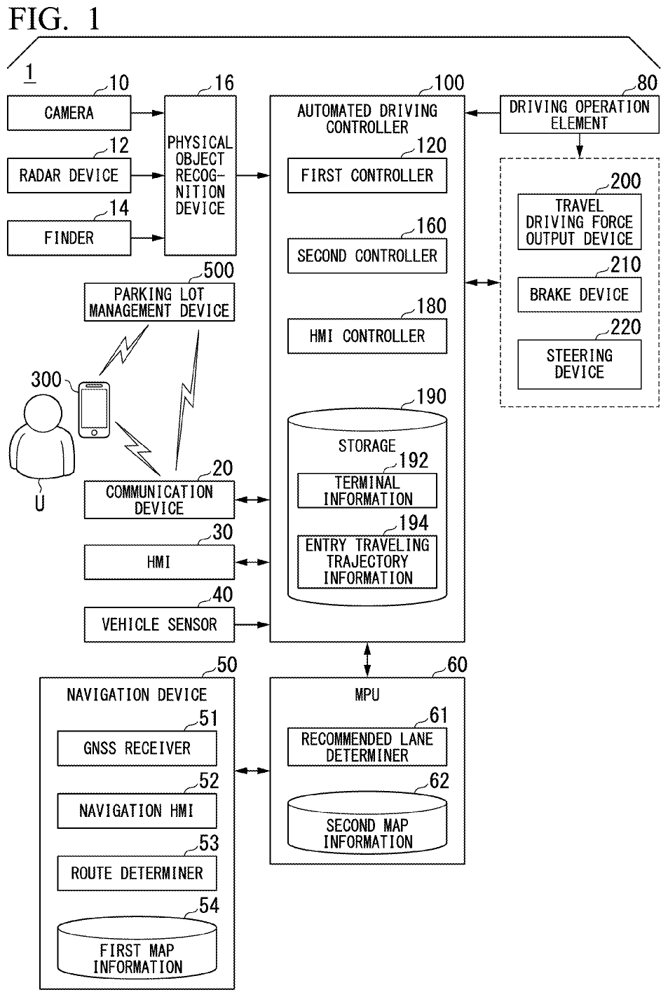

FIG. 1 is a configuration diagram of a vehicle system 1 including a vehicle control device according to an embodiment. For example, a vehicle on which the vehicle system 1 is mounted is, for example, a two-wheeled vehicle, a three-wheeled vehicle, or a four-wheeled vehicle. A driving source of the vehicle is an internal combustion engine such as a diesel engine or a gasoline engine, an electric motor, or a combination thereof. The electric motor is operated using electric power generated by an electric power generator connected to the internal combustion engine or discharge power of a battery (a storage battery) such as a secondary battery or a fuel cell.

For example, the vehicle system 1 includes a camera 10, a radar device 12, a finder 14, a physical object recognition device 16, a communication device 20, a human machine interface (HMI) 30, a vehicle sensor 40, a navigation device 50, a map positioning unit (MPU) 60, a driving operation element 80, an automated driving controller 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and parts of the configuration may be omitted or other configurations may be further added. A combination of the communication device 20 and the automated driving controller 100 is an example of the “vehicle control device”. The communication device 20 is an example of a “communicator”.

For example, the camera 10 is a digital camera using a solid-state imaging element such as a charge coupled device (CCD) or a complementary metal oxide semiconductor (CMOS). The camera 10 is attached to any position on the vehicle (hereinafter, a host vehicle M) on which the vehicle system 1 is mounted. When the view in front of the host vehicle M is imaged, the camera 10 is attached to an upper part of a front windshield, a rear surface of a rearview mirror, or the like. For example, the camera 10 periodically and iteratively images the surroundings of the host vehicle M. The camera 10 may be a stereo camera.

The radar device 12 radiates radio waves such as millimeter waves around the host vehicle M and detects at least a position (a distance to and a direction) of a physical object by detecting radio waves (reflected waves) reflected by the physical object. The radar device 12 is attached to any position on the host vehicle M. The radar device 12 may detect a position and speed of the physical object in a frequency modulated continuous wave (FM-CW) scheme.

The finder 14 is a light detection and ranging (LIDAR) finder. The finder 14 radiates light to the vicinity of the host vehicle M and measures scattered light. The finder 14 detects a distance to an object on the basis of time from light emission to light reception. The radiated light is, for example, pulsed laser light. The finder 14 is attached to any position on the host vehicle M.

The physical object recognition device 16 performs a sensor fusion process on detection results from some or all of the camera 10, the radar device 12, and the finder 14 to recognize a position, a type, a speed, and the like of a physical object. The physical object recognition device 16 outputs recognition results to the automated driving controller 100. The physical object recognition device 16 may output detection results of the camera 10, the radar device 12, and the finder 14 to the automated driving controller 100 as they are. The physical object recognition device 16 may be omitted from the vehicle system 1.

For example, the communication device 20 communicates with a terminal device 300 of a user U using the host vehicle M, another vehicle present in the vicinity of the host vehicle M, a parking lot management device 500, or various types of server devices on the basis of a communication state using, for example, a cellular network or a Wi-Fi network, Bluetooth (registered trademark), dedicated short range communication (DSRC), a local area network (LAN), a wide area network (WAN), or a network such as the Internet. The user U may be, for example, an owner of the host vehicle M or a user who only uses the host vehicle M through a rental car service, a car sharing service, or the like. The terminal device 300 is, for example, a mobile terminal such as a smartphone or a tablet terminal capable of being possessed by the user U. Hereinafter, the occupant of the host vehicle M is assumed to include the user U. Each of the communication device 20, the terminal device 300, and the parking lot management device 500 is connected so that communication with another device is enabled. Hereinafter, it is assumed that the communication with the communication device 20 may be replaced with communication with the host vehicle M.

The HMI 30 presents various types of information to an occupant of the host vehicle M and receives an input operation of the occupant. The HMI 30 includes various types of display devices, a speaker for the interior of the vehicle, a buzzer, a touch panel, a switch, keys, and the like. The display device includes, for example, a meter display provided in a portion of an instrument panel facing a driver, a center display provided at the center of the instrument panel, a head up display (HUD), and the like. For example, the HUD is a device that allows the occupant to visually recognize an image by superimposing the image on a landscape. As an example, the HUD projects light including an image on a front windshield or a combiner of the host vehicle M, thereby allowing the occupant to visually recognize a virtual image.

The vehicle sensor 40 includes a vehicle speed sensor configured to detect the speed of the host vehicle M, an acceleration sensor configured to detect acceleration, a yaw rate sensor configured to detect an angular speed around a vertical axis, a direction sensor configured to detect a direction of the host vehicle M, and the like. The vehicle sensor 40 may include a load sensor configured to detect a load of a seat located in the interior of the vehicle. A detection result of the vehicle sensor 40 is output to the automated driving controller 100.

For example, the navigation device 50 includes a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or corrected by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. For example, the route determiner 53 determines a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road and nodes connected by a link. The first map information 54 may include a curvature of a road, point of interest (POI) information, and the like. The route on the map is output to the MPU 60. The navigation device 50 may perform route guidance using the navigation HMI 52 on the basis of the route on the map. The navigation device 50 may be implemented, for example, according to a function of the terminal device 300. The navigation device 50 may transmit a current position and a destination to a navigation server via the communication device 20 and acquire a route equivalent to the route on the map from the navigation server. The navigation device 50 outputs the determined route on the map to the MPU 60.

For example, the MPU 60 includes a recommended lane determiner 61 and stores second map information 62 in a storage device such as an HDD or a flash memory. The recommended lane determiner 61 divides the route on the map provided from the navigation device 50 into a plurality of blocks (for example, divides the route every 100 [m] in a traveling direction of the vehicle), and determines a recommended lane for each block with reference to the second map information 62. The recommended lane determiner 61 determines what number lane the vehicle travels in from the left. The recommended lane determiner 61 determines the recommended lane so that the host vehicle M can travel along a reasonable route for traveling to a branching destination when there is a branch point in the route on the map.

The second map information 62 is map information which has higher accuracy than the first map information 54. For example, the second map information 62 includes information about a center of a lane, information about a boundary of a lane, and the like. The second map information 62 may include road information, traffic regulations information, address information (an address/postal code), facility information, parking lot information, telephone number information, and the like. The parking lot information includes, for example, a position and a shape of the parking lot, the number of vehicles that can be parked, the availability of automated driving, a getting-into/out area, a stopping area, and the like. The second map information 62 may be updated at any time when the communication device 20 communicates with another device.

For example, the driving operation element 80 includes an accelerator pedal, a brake pedal, a shift lever, a steering wheel, a steering wheel variant, a joystick, and other operation elements. A sensor configured to detect an amount of operation or the presence or absence of an operation is attached to the driving operation element 80, and a detection result thereof is output to the automated driving controller 100 or some or all of the travel driving force output device 200, the brake device 210, and the steering device 220.

The automated driving controller 100 includes, for example, a first controller 120, a second controller 160, the HMI controller 180, and a storage 190. The first controller 120, the second controller 160, and the HMI controller 180 are implemented, for example, by a hardware processor such as a central processing unit (CPU) executing a program (software). Some or all of these components are implemented, for example, by hardware (a circuit including circuitry) such as large scale integration (LSI), an application specific integrated circuit (ASIC), a field-programmable gate array (FPGA), or a graphics processing unit (GPU) or may be implemented by software and hardware in cooperation. The above-described program may be pre-stored in a storage device such as a storage device of the automated driving controller 100 (a storage device including a non-transitory storage medium) or may be stored in a removable storage medium such as a DVD, a CD-ROM, or a memory card and installed in the storage device of the automated driving controller 100 when the storage medium (the non-transitory storage medium) is mounted on a drive device, a card slot, or the like.

The storage 190 is implemented by the various types of storage devices described above. The storage 190 is implemented by, for example, an HDD, a flash memory, an EEPROM, a read only memory (ROM), a random access memory (RAM), or the like. The storage 190 stores, for example, terminal information 192, entry traveling trajectory information 194, the program, and other information.

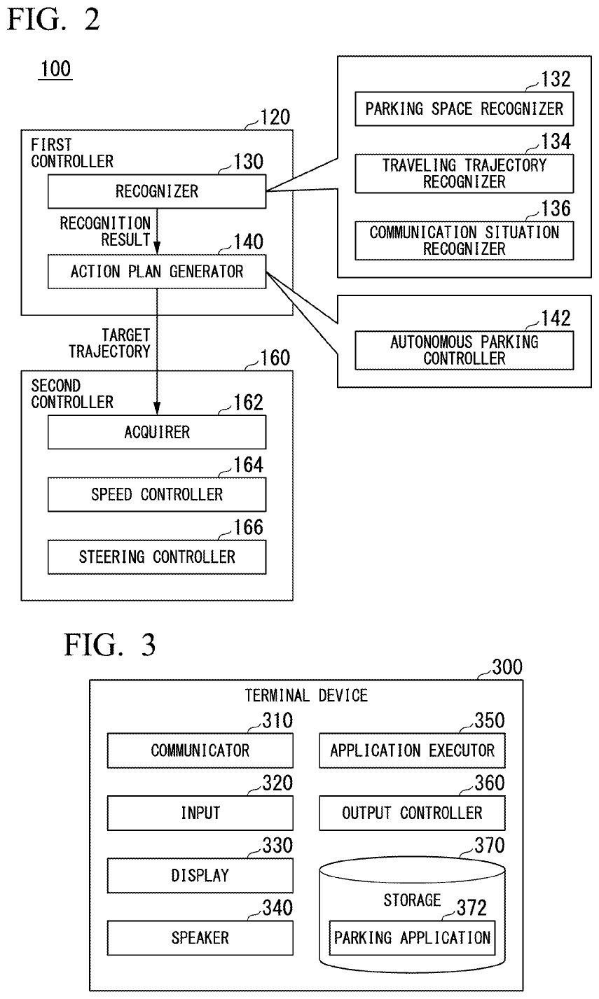

FIG. 2 is a functional configuration diagram of the first controller 120 and the second controller 160. The first controller 120 includes, for example, a recognizer 130, and an action plan generator 140. A combination of the action plan generator 140 and the second controller 160 is an example of a “driving controller”. For example, the first controller 120 implements a function based on artificial intelligence (AI) and a function based on a previously given model in parallel. For example, an “intersection recognition” function may be implemented by executing intersection recognition based on deep learning or the like and recognition based on previously given conditions (signals, road markings, or the like, with which pattern matching is possible) in parallel and performing comprehensive evaluation by assigning scores to both the recognitions.

Thereby, the reliability of automated driving is secured. For example, the first controller 120 executes control related to automated driving of the host vehicle M on the basis of an instruction from the MPU 60, the HMI controller 180, or the like and an instruction from the terminal device 300.

The recognizer 130 recognizes a surrounding environment of the host vehicle M on the basis of information input from the camera 10, the radar device 12, and the finder 14 via the physical object recognition device 16. For example, the recognizer 130 recognizes a state such as a position, velocity, or acceleration of a physical object present in the vicinity of the host vehicle M on the basis of the input information. For example, the physical object is a moving object such as another vehicle or an obstacle. For example, the position of the physical object is recognized as a position on absolute coordinates with a representative point (a center of gravity, a driving shaft center, or the like) of the host vehicle M as the origin and is used for control. The position of the physical object may be represented by a representative point such as a center of gravity or a corner of the physical object or may be represented by a represented region. When the physical object is a moving object such as another vehicle, the “state” of the physical object may include acceleration or jerk of the physical object or an “action state” (for example, whether or not a lane change is being made or intended).

For example, the recognizer 130 recognizes a lane in which the host vehicle M is traveling (a travel lane). For example, the recognizer 130 recognizes the travel lane by comparing a pattern of a road dividing line (for example, an arrangement of solid lines and broken lines) obtained from the second map information 62 with a pattern of road dividing lines in the vicinity of the host vehicle M recognized from an image captured by the camera 10 (hereinafter referred to as a captured image). The recognizer 130 may recognize a travel lane by recognizing a traveling path boundary (a road boundary) including a road dividing line, a road shoulder, a curbstone, a median strip, a guardrail, or the like as well as a road dividing line. In this recognition, a position of the host vehicle M acquired from the navigation device 50 or a processing result of the INS may be added. The recognizer 130 recognizes a temporary stop line, an obstacle, red traffic light, a toll gate, an entrance/exit gate of a parking area, a stopping area, a getting-into/out area, and other road events.

When a travel lane is recognized, the recognizer 130 recognizes a position or orientation of the host vehicle M with respect to the travel lane or a parking space (an example of a parking place). For example, the recognizer 130 may recognize a gap of a reference point of the host vehicle M from the center of the lane and an angle formed with respect to a line connecting the center of the lane in the travel direction of the host vehicle M as a relative position and orientation of the host vehicle M related to the travel lane. Alternatively, the recognizer 130 may recognize a position of the reference point of the host vehicle M related to one side end portion (a road dividing line or a road boundary) of the travel lane or the like as a relative position of the host vehicle M related to the travel lane.

The recognizer 130 includes, for example, a parking space recognizer 132, a traveling trajectory recognizer 134, and a communication situation recognizer 136. Details of functions of the parking space recognizer 132, the traveling trajectory recognizer 134, and the communication situation recognizer 136 will be described below.

The action plan generator 140 generates an action plan for causing the host vehicle M to travel according to automated driving. For example, the action plan generator 140 generates a future target trajectory along which the host vehicle M automatedly travels (independently of a driver's operation) so that the host vehicle M can generally travel in the recommended lane determined by the recommended lane determiner 61 and further cope with a surrounding situation of the host vehicle M on the basis of a recognition result of the recognizer 130. For example, the target trajectory includes a speed element. For example, the target trajectory is represented by sequentially arranging points (trajectory points) at which the host vehicle M is required to arrive. The trajectory points are points at which the host vehicle M is required to arrive for each predetermined traveling distance (for example, about several meters [m]) along a road. In addition, a target speed and target acceleration for each predetermined sampling time (for example, about several tenths of a second [sec]) are generated as parts of the target trajectory. The trajectory point may be a position at which the host vehicle M is required to arrive at the sampling time for each predetermined sampling time. In this case, information about the target speed or the target acceleration is represented by an interval between the trajectory points.

The action plan generator 140 may set an automated driving event when the target trajectory is generated. The automated driving event includes a constant-speed traveling event, a low-speed following traveling event, a lane change event, a branching event, a merging event, a takeover event, an autonomous parking event for parking the vehicle according to automated driving in a parking lot in a valet parking or the like, and the like. The action plan generator 140 generates a target trajectory according to the activated event. For example, the action plan generator 140 includes an autonomous parking controller 142 that is activated when the autonomous parking event is executed. Details of the function of the autonomous parking controller 142 will be described below.

The second controller 160 controls the travel driving force output device 200, the brake device 210, and the steering device 220 so that the host vehicle M passes through the target trajectory generated by the action plan generator 140 at a scheduled time.

The second controller 160 includes, for example, an acquirer 162, a speed controller 164, and a steering controller 166. The acquirer 162 acquires information of a target trajectory (trajectory points) generated by the action plan generator 140 and causes the acquired information to be stored in a memory (not shown). The speed controller 164 controls the travel driving force output device 200 or the brake device 210 on the basis of speed elements associated with the target trajectory stored in the memory. The steering controller 166 controls the steering device 220 in accordance with a degree of curve of a target trajectory stored in the memory. For example, processes of the speed controller 164 and the steering controller 166 are implemented by a combination of feed-forward control and feedback control. As one example, the steering controller 166 executes feed-forward control according to the curvature of the road in front of the host vehicle M and feedback control based on a deviation from the target trajectory in combination.

Returning to FIG. 1, the HMI controller 180 notifies the occupant of predetermined information by means of the HMI 30. The predetermined information may include information related to traveling of the host vehicle M such as information about the state of the host vehicle M and information about driving control. The information about the state of the host vehicle M includes, for example, a speed of the host vehicle M, an engine speed, a shift position, and the like. The information about the driving control includes, for example, information about whether or not automated driving is to be executed, information about presetting for starting automated driving, information for asking about whether or not to start automated driving, information about a degree of driving assistance based on automated driving, and the like. The predetermined information may include information that is not related to the traveling of the host vehicle M, such as content (for example, a movie) stored in a storage medium such as a TV program or a DVD. The predetermined information may include, for example, information about a communication state between the host vehicle M and the terminal device 300, a current position and a destination in automated driving, and the remaining amount of fuel of the host vehicle M. The HMI controller 180 may output information received by the HMI 30 to the communication device 20, the navigation device 50, the first controller 120, and the like.

Also, the HMI controller 180 may communicate with the terminal device 300 stored in the terminal information 192 or the parking lot management device 500 via the communication device 20 and transmit predetermined information to the terminal device 300 or the parking lot management device 500. The HMI controller 180 may cause the HMI 30 to output information acquired from the terminal device 300 or the parking lot management device 500. For example, when the communication device 20 has received an inquiry from the terminal device 300 or the parking lot management device 500, the HMI controller 180 may generate a response to the inquiry by the automated driving controller 100 and cause the generated response to be transmitted to the terminal device 300 or the parking lot management device 500 that has sent the inquiry.

For example, the HMI controller 180 may perform control for causing the display device of the HMI 30 to display a registration screen for registering the terminal device 300 that communicates with the host vehicle M and causing information about the terminal device 300 input via the registration screen to be stored in the storage 190 as terminal information 192. The above-described registration of the terminal information 192 is executed, for example, at a predetermined timing when the user U gets into the vehicle or before the automated driving such as the autonomous parking event is started. The above-described registration of the terminal information 192 may be executed by an application program (a parking application to be described below) installed in the terminal device 300.

The travel driving force output device 200 outputs a travel driving force (torque) for enabling the vehicle to travel to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described components in accordance with information input from the second controller 160 or information input from the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the driving operation element 80 so that brake torque according to a braking operation is output to each wheel. The brake device 210 may include a mechanism configured to transfer the hydraulic pressure generated by an operation of the brake pedal included in the driving operation element 80 to the cylinder via a master cylinder as a backup. Also, the brake device 210 is not limited to the above-described configuration and may be an electronically controlled hydraulic brake device configured to control the actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the driving operation element 80 to change the direction of the steerable wheels.

### [Terminal Device]

FIG. 3 is a diagram showing an example of a functional configuration of the terminal device 300. The terminal device 300 includes, for example, a communicator 310, an input 320, a display 330, a speaker 340, an application executor 350, an output controller 360, and a storage 370. The communicator 310, the input 320, the application executor 350, and the output controller 360 are implemented, for example, by a hardware processor such as a CPU executing a program (software). Some or all of these components are implemented, for example, by hardware (a circuit including circuitry) such as LSI, an ASIC, an FPGA, or a GPU or may be implemented by software and hardware in cooperation. The above-described program may be pre-stored in a storage device such as an HDD or a flash memory provided in the terminal device 300 (a storage device including a non-transitory storage medium) or may be stored in a removable storage medium such as a DVD, a CD-ROM, or a memory card and installed in the storage device of the terminal device 300 when the storage medium (the non-transitory storage medium) is mounted on a drive device, a card slot, or the like.

The storage 370 is implemented by the various types of storage devices described above. Also, the storage 370 is implemented by, for example, an HDD, a flash memory, an EEPROM, a ROM, a RAM, or the like. The storage 370 stores, for example, a parking application 372, a program, and other various types of information.

For example, the communicator 310 communicates with the host vehicle M, the parking lot management device 500, and other external devices on the basis of a communication state using a cellular network, a Wi-Fi network, Bluetooth (registered trademark), a DSRC, or a network such as a LAN, a WAN, or the Internet.

For example, the input 320 receives the input from the user U by operating various types of keys and buttons and the like. The display 330 is, for example, a liquid crystal display (LCD) or the like. The input 320 may be configured integrally with the display 330 as a touch panel. The display 330 displays information about automated driving in the embodiment and other information necessary for using the terminal device 300 according to the control of the output controller 360. For example, the speaker 340 outputs a predetermined sound according to the control of the output controller 360.

The application executor 350 is implemented by the processor executing the parking application 372 stored in the storage 370. For example, the parking application 372 is an application program (an application) for communicating with the host vehicle M or the parking lot management device 500 of the destination facility to be visited via a network and transmitting an automated entering request, an automated leaving request, or the like according to automated driving to the parking lot management device 500 or the host vehicle M.

The application executor 350 may recognize a state of communication with the parking lot management device 500 or the host vehicle M and switch a target to which an entering instruction or a leaving instruction is transmitted in accordance with a recognition result. In this case, the application executor 350 receives a specific signal (for example, a heartbeat signal) transmitted from the host vehicle M or the parking lot management device 500 at predetermined time intervals or transmits an inquiry signal for inquiring about an operation and recognizes the communication state of the communication device 20 of the host vehicle M or the parking lot management device 500 on the basis of a reception state of a response signal or content of the signal. For example, when the specific signal has been received at predetermined time intervals or when the response signal has been received, the application executor 350 recognizes that a state of communication with a device that has transmitted the specific signal or the response signal is normal. Also, for example, when no specific signal can be received at predetermined time intervals, or when no response signal has been received within a predetermined period, the application executor 350 recognizes that a communication state of a device that has not transmitted the specific signal or the response signal is not normal (that the communication state is abnormal). Also, when the above-described recognized normal or abnormal state has continued for a predetermined time period or more, the application executor 350 may finally recognize that the communication state is normal or abnormal. The application executor 350 determines whether or not the parking lot management device 500 is in an abnormal state according to whether or not the communicator 310 has received information indicating an abnormal state transmitted from the parking lot management device 500. The abnormal state in this case is, for example, a case in which the communication state is normal, but the parking lot management device 500 itself is abnormal (a case in which entering or leaving of the vehicle cannot be managed due to a processing load, a processing error, or the like).

Thereby, for example, the application executor 350 transmits an automated entering request or an automated leaving request to the parking lot management device 500 when the state of communication with the parking lot management device 500 is normal. The application executor 350 transmits an automated entering instruction, an automated leaving instruction, or the like by switching a transmission destination to the host vehicle M when the state of communication with the parking lot management device 500 is abnormal or the parking lot management device 500 itself is in an abnormal state and the state of communication with the host vehicle M is normal.

Also, the application executor 350 acquires information transmitted by the parking lot management device 500 or the host vehicle M and causes the output controller 360 to execute a predetermined notification on the basis of the acquired information. The predetermined notification is, for example, the image display on the display 330 and the sound output from the speaker 340. For example, the application executor 350 may make notification content to be output different between a case in which an object that requests automated entering or automated leaving is the parking lot management device 500 and a case in which communication with the parking lot management device 500 is impossible and switching to the host vehicle M is performed.

Also, the application executor 350 may transmit position information of the terminal device 300 acquired by a global positioning system (GPS) device (not shown) built in the terminal device 300 to the parking lot management device 500 or the host vehicle M, register the terminal information, the notification content, and the like, or perform other processes related to vehicle cooperation.

The output controller 360 controls content or a display mode of an image displayed on the display 330 and content or an output mode of a sound to be output to the speaker 340 according to an instruction of the application executor 350. For example, the output controller 360 may cause the display 330 to display information about driving control (automated entering and automated leaving) from the host vehicle M, information for inquiring about an instruction of the driving control and the locking state, and the like or cause the speaker 340 to output a sound corresponding to the above-described information. The output controller 360 may acquire an image or a sound corresponding to the notification content from an external device directly or generate an image or a sound within the terminal device 300 to cause the image or the sound to be output from the display 330 and the speaker 340. The output controller 360 may cause various types of information necessary to use the terminal device 300 to be output from the display 330 and the speaker 340.

### [Driving Control Based on Automated Driving]

Next, the driving control based on the automated driving according to the embodiment will be specifically described. Hereinafter, an example of the driving control in the traveling based on the automated driving of the host vehicle M will be described using a scene in which autonomous parking based on the automated driving is performed in valet parking of a destination facility to be visited that is an example of an area including a parking lot. In the following, parking in “unmanned traveling” in which traveling is performed in an unmanned manner is assumed to be used as an example of “autonomous parking”. The automated driving in the present embodiment may be performed in a state in which the occupant is in the vehicle.

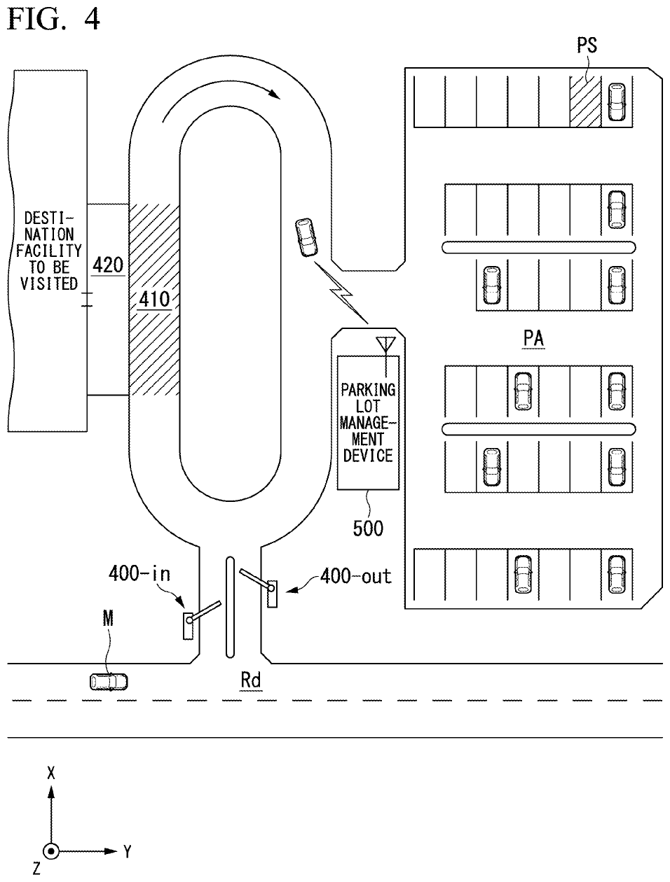

FIG. 4 is a diagram schematically showing a scene in which an autonomous parking event is executed in the embodiment. In the example of FIG. 4, a parking lot (for example, valet parking) PA of the destination facility to be visited is shown. In the parking lot PA, gates 400-in and 400-out, a stopping area 410, and a getting-into/out area 420 are assumed to be provided along a route from a road Rd to the destination facility to be visited. In the example of FIG. 4, the parking lot management device 500 for controlling a parking situation of the parking lot PA or the entering or leaving of the vehicle is assumed to be provided.

Here, processes at the time of automated entering and the time of automated leaving of the host vehicle M due to the autonomous parking event will be described. Different processes are executed at the time of automated entering and the time of automated leaving on the basis of communication states of the terminal device 300, the host vehicle M, and the parking lot management device 500. When the communication state is determined, the host vehicle M determines whether or not the communication state is normal by recognizing a state of communication with the terminal device 300 or the parking lot management device 500 on the basis of a specific signal or a response signal in the communication situation recognizer 136 as in the above-described process of the application executor 350. The vehicle M may determine whether or not the parking lot management device 500 is in the abnormal state according to whether or not information indicating the abnormal state transmitted from the parking lot management device 500 has been received. Also, the parking lot management device 500 determines whether or not a state of communication with the terminal device 300 or the host vehicle M is normal on the basis of the specific signal and the response signal in the communication state manager 522 to be described below as in the process of the application executor 350. Hereinafter, driving control of autonomous parking according to the communication states of the terminal device 300, the host vehicle M, and the parking lot management device 500 will be described for each of several control patterns. Also, each control pattern including the operations of the terminal device 300 and the parking lot management device 500 will be described.

### [First Control Pattern]

In a first control pattern, automated entering and automated leaving when all communication states of the terminal device 300, the host vehicle M, and the parking lot management device 500 are normal will be described. When all the communication states are normal, an automated entering request and an automated leaving request are transmitted from the terminal device 300 to the parking lot management device 500, a route to the parking space (an example of a parking place) PS is indicated from the parking lot management device 500 to the host vehicle M and the host vehicle M executes the automated entering and the automated leaving along the route indicated from the parking lot management device 500 (hereinafter referred to as an instruction route). Also, execution conditions of the automated entering and the automated leaving of the host vehicle M are not limited to the above-described conditions and may be executed, for example, when a preset time period has elapsed or when other execution conditions are satisfied.

### [Automated Entering]

First, the automated entering in the first control pattern will be described. The host vehicle M moves to the stopping area 410 through the gate 400-in shown in FIG. 4 according to manual driving or automated driving. The stopping area 410 faces the getting-into/out area 420 connected to the destination facility to be visited. Eaves for avoiding rain and snow are provided in the getting-into/out area 420. After the occupant (hereinafter referred to as the user U) gets out of the stopping area 410, the host vehicle M performs unmanned automated driving and starts an autonomous parking event in which the host vehicle M moves to the parking space PS within the parking lot PA.

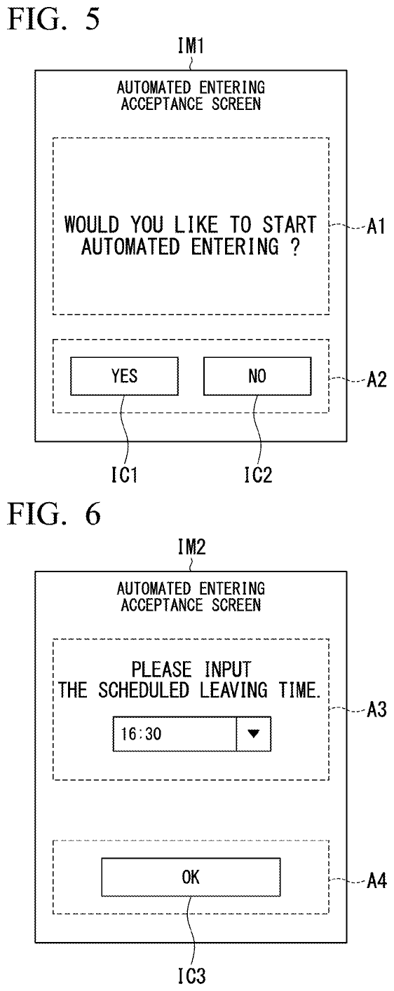

Also, before the execution of the autonomous parking event (the automated entering), the terminal device 300 first displays an automated entering acceptance screen for inquiring of the user U about whether to perform the automated entering. FIG. 5 is a diagram showing an example of an image IM1 displayed on the display 330 of the terminal device 300 as the automated entering acceptance screen. The image IM1 shown in FIG. 5 is generated by, for example, the output controller 360. Also, an image layout and displayed content are not limited to the images shown in FIG. 5. The same applies to the description of images of FIG. 6 and subsequent drawings.

For example, the output controller 360 may cause the image IM1 shown in FIG. 5 to be displayed according to a display instruction of the user U or cause the image IM1 shown in FIG. 5 to be displayed at a predetermined timing after it is estimated that the user U has gotten out of the host vehicle M or the like. For example, the determination as to whether or not the user U has gotten out of the host vehicle M is made according to whether or not the recognizer 130 has recognized the user U from facial feature information or the like according to an analysis result of the image captured by the camera 10 or is made according to whether or not a load on a seat detected by the load sensor of the vehicle sensor 40 is less than or equal to a threshold value. The recognizer 130 transmits an instruction for causing the terminal device 300 to display an automated entering acceptance screen via the communication device 20 when the user U has been recognized according to an analysis result of the image captured by the camera 10 on the basis of a result of recognition via the communication device 20 or when the load on the seat detected by the load sensor is less than or equal to the threshold value. The output controller 360 of the terminal device 300 causes the display 330 to display the image IM1 shown in FIG. 5 on the basis of the above-described instruction.

In the example of FIG. 5, the image IM1 includes a text information display area A1 and a selection item display area A2 as the automated entering acceptance screen. In the text information display area A1, for example, text information for inquiring the user U about whether or not to start automated entering is displayed. In the example of FIG. 5, text information such as “Would you like to start automated entering?” is displayed in the text information display area A1.

The selection item display area A2 includes a graphical user interface (GUI) icon IC1 (a YES button) for accepting the approval for content displayed in the text information display area A1 and a GUI icon IC2 (a NO button) for accepting the disallowance for the displayed content.

Also, the output controller 360 may cause a sound corresponding to the text information displayed in the text information display area A1 to be output from the speaker 340 in addition to (or instead of) displaying the image IM1 described above. The same applies to the description of subsequent images.

When the operation of the GUI icon IC1 has been received by the input 320, the output controller 360 generates an image IM2 for inputting the scheduled leaving time and causes the display 330 to output the generated image IM2. FIG. 6 is a diagram showing an example of the image IM2 for inputting the scheduled leaving time. The image IM2 includes a time input area A3 and a selection item display area A4. In the time input area A3, for example, text information for prompting the user U to input the scheduled leaving time and a GUI widget for inputting the scheduled leaving time are displayed. In the example of FIG. 6, text information such as “Please input the scheduled leaving time” and a combo box in which a time can be input by selecting one of a plurality of times displayed in a drop-down list or by directly inputting a number using the input 320 are displayed in the time input area A3.

The selection item display area A4 includes a GUI icon IC3 (an OK button) for accepting the approval for content input in the text information display area A3. When the input 320 has received the operation of the GUI icon IC3 by the user U, the output controller 360 causes the display of the image IM2 to end. Information about the automated entering request and the scheduled leaving time is transmitted to the parking lot management device 500 together with information about an entering target vehicle (for example, a vehicle ID). Also, when the GUI icon IC2 has been selected in the image IM1 shown in FIG. 5, the output controller 360 ends the display of the image IM1.

The parking lot management device 500 communicates with the host vehicle M on the basis of the information about the automated entering request and the scheduled leaving time transmitted from the terminal device 300 and causes the host vehicle M to travel to a predetermined parking space PS.

For example, the autonomous parking controller 142 of the host vehicle M causes the host vehicle M to park within the parking space PS of the parking lot PA on the basis of information acquired from the parking lot management device 500 by the communication device 20. Specifically, when the autonomous parking event is started, the autonomous parking controller 142 controls the communication device 20 so that the communication device 20 receives an automated entering instruction from the parking lot management device 500. The host vehicle M moves from the stopping area 410 to the parking lot PA in accordance with the guidance of the parking lot management device 500 or while performing sensing on its own.

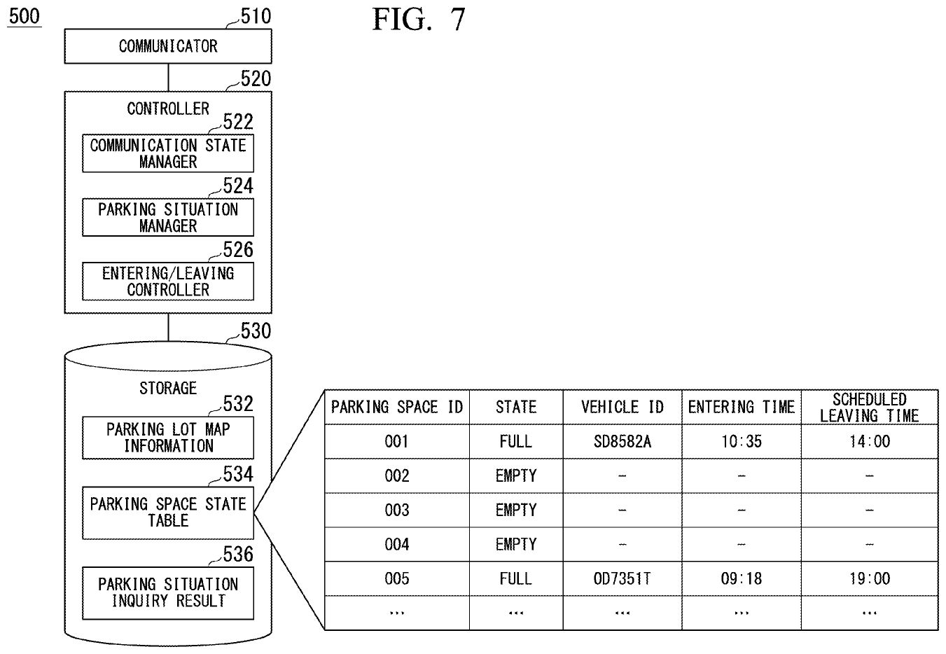

FIG. 7 is a diagram showing an example of a configuration of the parking lot management device 500. The parking lot management device 500 includes, for example, a communicator 510, a controller 520, and a storage 530. The controller 520 includes, for example, a communication state manager 522, a parking situation manager 524, and an entering/leaving controller 526. The communicator 510 and the controller 520 are implemented by, for example, a hardware processor such as a CPU executing a program (software). Some or all of these components are implemented, for example, by hardware (a circuit including circuitry) such as LSI, an ASIC, an FPGA, or a GPU or may be implemented by software and hardware in cooperation. The above-described program may be pre-stored in a storage device (a storage device including a non-transitory storage medium) such as an HDD or a flash memory of the parking lot management device 500 or may be stored in a removable storage medium such as a DVD, a CD-ROM, or a memory card and installed in the storage device of the terminal device 300 when the storage medium (the non-transitory storage medium) is mounted in a drive device, a card slot, or the like.

The storage 530 is implemented by the various types of storage devices described above. The storage 530 is implemented by, for example, an HDD, a flash memory, an EEPROM, a ROM, a RAM, or the like. The storage 530 stores, for example, parking lot map information 532, a parking space state table 534, a parking situation inquiry result 536, programs, and other various types of information.

The communicator 510 wirelessly communicates with the host vehicle M, other vehicles, the terminal device 300, and the like on the basis of a communication state of the communication state manager 522. The communication state manager 522 determines whether or not the state of communication with the terminal device 300 or the vehicle M is normal on the basis of a specific signal or a response signal. The communication state manager 522 recognizes that the communication state has been changed (restored) from a state that is not normal (an abnormal state) to a normal state. The parking situation manager 524 guides the vehicle to the parking space PS on the basis of the information acquired by the communicator 510 and the information stored in the storage 530.

The parking lot map information 532 is information geometrically representing the structure of the parking lot PA. The parking lot map information 532 includes coordinates for each parking space PS. In the parking space state table 534, for example, a state which is an empty state or a full (parked) state, a vehicle ID which is identification information of a parked vehicle in the case of the full state, an entering time at which the vehicle enters the parking space PS, and a scheduled leaving time at which the vehicle leaves the parking space PS are associated with a parking space ID which is identification information of the parking space PS. The entering time is the time when the host vehicle M parked in the parking space PS. Also, the entering time may be the time when the host vehicle M passed through the gate 400-in or the time when automated entering started from a point P1 where the vehicle stopped in the stopping area 410. The scheduled leaving time is, for example, the time specified by the user U using the terminal device 300. The entering time and the scheduled leaving time may be stored in the storage 190 of the host vehicle M. In the parking situation inquiry result 536, information including a result of inquiring about the parking situation of each vehicle present within the parking lot PA in the parking situation manager 524 is stored. Details of the parking situation inquiry result 536 will be described below.

When the entering instruction (the automated entering request) of the host vehicle M is received from the terminal device 300 of the user U, the parking situation manager 524 extracts a parking space PS whose state is empty with reference to the parking space state table 534, acquires a position of the extracted parking space PS from the parking lot map information 532, and transmits a preferable route to the acquired position of the parking space PS to the host vehicle M using the communicator 510. Also, the parking situation manager 524 instructs a specific vehicle to stop or slow down, as necessary, on the basis of a positional relationship of a plurality of vehicles present within the parking lot PA so that the vehicles do not move to the same position at the same time.

The autonomous parking controller 142 of the host vehicle M that has received the instruction route (hereinafter referred to as an entering instruction route) from the parking lot management device 500 generates a target trajectory based on the entering instruction route as an automated entering process. Also, when the host vehicle M approaches the target parking space PS, the parking space recognizer 132 recognizes parking slot lines that partition the parking space PS and the like, recognizes a detailed position of the parking space PS, and provides the recognized position to the autonomous parking controller 142. The autonomous parking controller 142 receives the provided position to correct the target trajectory and cause the host vehicle M to be parked in the parking space PS.

The autonomous parking controller 142 may find an empty parking space on its own on the basis of a detection result of the camera 10, the radar device 12, the finder 14, or the physical object recognition device 16 independently of communication and cause the host vehicle M to be parked within the found parking space without being limited to the above description.

The parking situation manager 524 sets information indicating a full state (for example, “full” shown in FIG. 7) in the “state” of the parking space state table 534 associated with the parking space ID of the parking space PS where the host vehicle M is parked and stores the vehicle ID, the entering time, and the scheduled leaving time of the host vehicle M.

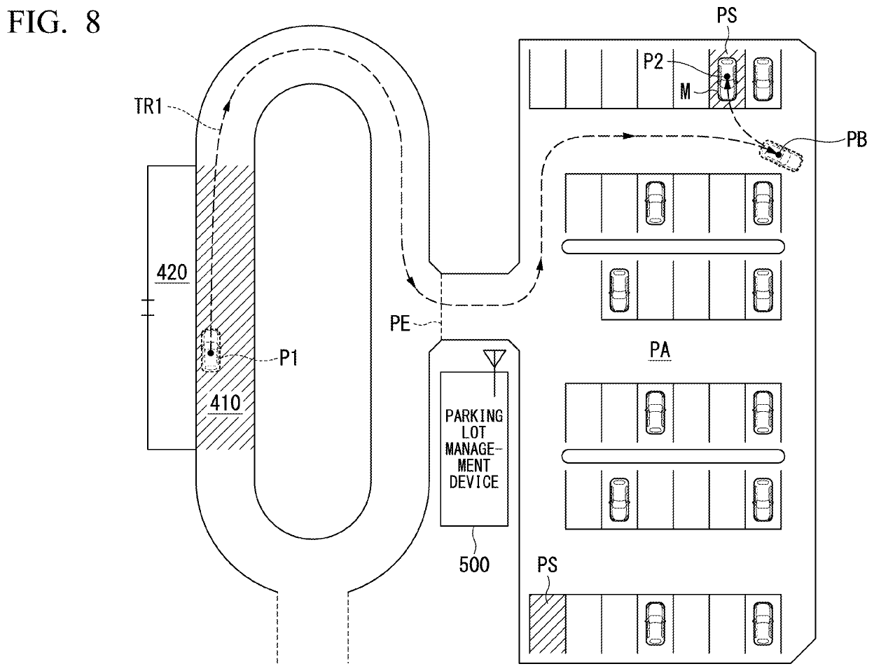

The traveling trajectory recognizer 134 recognizes, for example, a traveling route until the host vehicle M is parked in the parking space PS from a point where the host vehicle M has started automated entering. FIG. 8 is a diagram for describing the traveling trajectory recognizer 134. FIG. 8 shows an extracted part of the parking lot PA of the destination facility to be visited shown in FIG. 4 described above. The traveling trajectory recognizer 134 sets a point where the entering instruction route has been received from the parking lot management device 500 (a stop point in the stopping area 410 where the user U has gotten out of the host vehicle M in the getting-into/out area 420 in the example of FIG. 8) as a start point P1 and recognizes a traveling trajectory TR1 to a point where the host vehicle M is parked in the parking space PS (hereinafter referred to as an end point P2) after actual traveling along the entering instruction route. The traveling trajectory TR1 includes, for example, a point through which a reference point of the host vehicle M (for example, the center or the center of gravity of the host vehicle M) passes on the road. The traveling trajectory recognizer 134 may use a predetermined point within the stopping area 410 or an entrance point of the parking lot PA (a point PE shown in FIG. 8) instead of the start point P1. The traveling trajectory recognizer 134 may recognize the traveling route at the time of entering according to manual driving of the user U, for example, instead of the traveling route based on the entering instruction route from the parking lot management device 500.

Also, the traveling trajectory recognizer 134 may recognize information about the behavior of the host vehicle M at the time of entering. The information about the behavior is, for example, information about a speed of the host vehicle M at the time of entering and a vehicle direction (for example, forward movement, backward movement, or a steering angle) with respect to a traveling direction. For example, the traveling trajectory recognizer 134 recognizes that the host vehicle M travels forward from the start point P1 to a point PB and travels backward (performs back traveling) from the point PB to the end point P2 in the entire traveling trajectory TR1. The traveling trajectory recognizer 134 stores information including information about the traveling trajectory TR1 and the behavior as the entry traveling trajectory information 194 in the storage 190.

### [Automated Leaving]

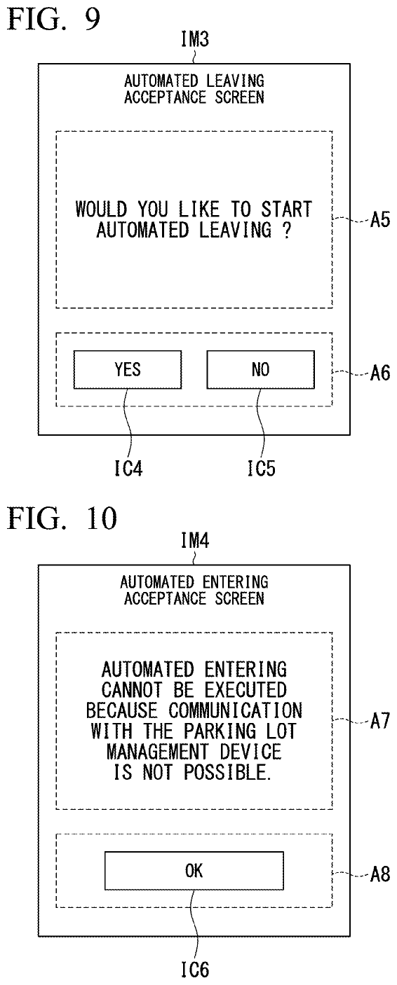

Next, automated leaving in the first control pattern will be described. It is assumed that the autonomous parking controller 142 and the communication device 20 maintain the operating state even if the host vehicle M is parked. Before the execution of the autonomous parking event (automated leaving), the terminal device 300 first displays an automated leaving acceptance screen for inquiring of the user U about whether or not to perform the automated leaving. FIG. 9 is a diagram showing an example of an image IM3 displayed on the display 330 of the terminal device 300 as the automated leaving acceptance screen. For example, the output controller 360 may cause the image IM3 shown in FIG. 9 to be displayed according to a display instruction of the user U or to be displayed at the timing when an inquiry from the parking lot management device 500 is made when the current time has reached the scheduled leaving time.

In the example of FIG. 9, the image IM3 includes a text information display area A5 and a selection item display area A6 as the automated leaving acceptance screen. In the text information display area A5, for example, text information for inquiring the user U about whether or not to start automated leaving is displayed. In the example of FIG. 9, text information such as “Would you like to start automated leaving?” is displayed in the text information display area A5.

The selection item display area A6 includes a GUI icon IC4 (a YES button) for accepting the approval for content displayed in the text information display area A5 and a GUI icon IC5 (a NO button) for accepting the disallowance for the displayed content.

When the operation of the GUI icon IC4 has been received by the input 320, the output controller 360 transmits an automated leaving request for executing automated leaving to the parking lot management device 500 together with information about a leaving target vehicle (for example, a vehicle ID) and ends the display of the image IM3. When the operation of the GUI icon IC5 has been received by the input 320, the output controller 360 ends the display of the image IM3.

When the automated leaving request transmitted by the terminal device 300 has been received, the parking situation manager 524 of the parking lot management device 500 communicates with the host vehicle M and outputs a leaving instruction route for causing the host vehicle M to leave a predetermined parking space PS (for example, a route from the parking space PS to the stopping area 410).

For example, the autonomous parking controller 142 causes the system of the host vehicle M to be activated on the basis of the automated leaving instruction received from the parking lot management device 500 by the communication device 20 and executes the automated leaving. The autonomous parking controller 142 receives the leaving instruction route from the parking lot management device 500 and causes the host vehicle M to move to the stopping area 410 on the basis of the received leaving instruction route. At this time, the autonomous parking controller 142 controls the communication device 20 so that the communication device 20 transmits position information of the host vehicle M to the parking lot management device 500. The controller 520 of the parking lot management device 500 instructs a specific vehicle to stop or slow down, as necessary, on the basis of a positional relationship of a plurality of vehicles so that the vehicles do not move to the same position at the same time on the basis of the position information of the host vehicle M as in the entering process. The autonomous parking controller 142 determines whether or not the user U is present in a getting-into/out area (a getting-into area when the getting-into area and a getting-out area are separated) 420 and causes the host vehicle M to stop in the empty space of the stopping area 410 within a predetermined distance from a position where the user U is present when it is determined that the user U is present. In this case, the autonomous parking controller 142 acquires the position information from the terminal device 300 and determines that the user U is present in the getting-into/out area 420 when the acquired position information is within the getting-into/out area 420. The autonomous parking controller 142 may determine whether or not the user U is present in the getting-into/out area 420 on the basis of a detection result of the camera 10, the radar device 12, the finder 14, or the physical object recognition device 16. In this case, the autonomous parking controller 142 acquires feature information of the user U from the detection result of the camera 10, the radar device 12, the finder 14, or the physical object recognition device 16 in advance before the host vehicle M performs an entering process. The autonomous parking controller 142 compares feature information of a person obtained from the detection result at the time of leaving with the feature information of the user U and determines that the user U is present when a degree of similarity is greater than or equal to a predetermined value.

After the user U is allowed to get into the vehicle after stopping, an operation of the autonomous parking controller 142 is stopped and the manual driving or the automated driving by another functional unit is subsequently started. In this case, for example, the autonomous parking controller 142 determines that the user U is in the host vehicle M when the opening or closing of the door of the host vehicle M is detected, when an operation on the driving operation element 80 or the HMI 30 is received, or when it is detected that the load on the vehicle interior seat is greater than or equal to a predetermined value.

When it is determined that the user U is not present in the getting-into/out area 420, the autonomous parking controller 142 may perform control for causing the host vehicle M to slow down and causing the time until the host vehicle M reaches the stopping area 410 to be delayed. Thereby, the waiting time in the stopping area 410 can be shortened and congestion in the stopping area 410 can be reduced.

When a time period elapsed after stopping in the stopping area 410 is greater than or equal to a predetermined time period and a getting-into process of the user U is not detected, the autonomous parking controller 142 may generate a circulation path along which the vehicle goes round the stopping area 410 and execute automated driving in which the vehicle goes round the stopping area 410 along the circulation path. When the above-described conditions are satisfied, the autonomous parking controller 142 may execute automated driving for causing the vehicle to be parked in the parking lot PA again. Thereby, traffic congestion in the stopping area 410 can be curbed.

The autonomous parking controller 142 may delete the entry traveling trajectory information 194 stored in the storage 190 when the automated leaving based on the instruction from the parking lot management device 500 has been completed. When the automated leaving of the host vehicle M has been completed, the parking situation manager 524 sets “empty” indicating an empty state in the “state” item associated with the parking space ID of the parking space PS in which the host vehicle M is parked in the parking space state table 534 and deletes the vehicle ID, the entering time, and the scheduled leaving time of the host vehicle M.

Although a process for the host vehicle M has been mainly described in the first control pattern, the parking lot management device 500 also performs a similar process with respect to other vehicles in the destination facility to be visited and executes control related to entering or leaving. The same applies to the description of the subsequent control patterns.

### [Second Control Pattern]

In a second control pattern, automated entering and automated leaving when communication states of some of the terminal device 300, the host vehicle M, and the parking lot management device 500 are not normal or the device itself is in an abnormal state will be described. Hereinafter, a case in which the communication state is not normal will be mainly described using the parking lot management device 500 as an example of the device. Also, in the following, differences from the first control pattern will be mainly described and the description of common parts will be omitted.

### [Automated Entering]

In the second control pattern, the terminal device 300 first causes the display 330 to display the image IM1 shown in FIG. 5 described above for the user U. When the operation of the GUI icon IC1 by the user U has been received, the input 320 transmits an automated entering request to the parking lot management device 500. However, no automated entering can be executed because the communication state of the parking lot management device 500 is not normal in the second control pattern. Thus, the output controller 360 causes the display 330 to display information indicating that the automated entering process cannot be executed.

FIG. 10 is a diagram showing an example of an image IM4 indicating that the automated entering process cannot be executed. In the example of FIG. 10, the image IM4 includes a text information display area A7 and a selection item display area A8. In the text information display area A7, for example, information indicating that automated entering cannot be executed and information indicating the reason why automated entering cannot be executed are displayed. In the example of FIG. 10, text information such as “Automated entering cannot be executed because communication with the parking lot management device is not possible” is displayed in the text information display area A7.

The selection item display area A8 includes a GUI icon IC6 (an OK button) for accepting the approval for content displayed in the text information display area A7. When the input 320 has received the operation of the GUI icon IC6 by the user U, the output controller 360 causes the display of the image IM4 to end. Thereby, the user U is allowed to ascertain that automated entering cannot be executed and the reason why automated entering cannot be executed. As a result, the user U can take a measure such as parking in a method other than automated entering (for example, manual driving) or making an automated entering request again after the lapse of a predetermined time period because there is a possibility of the communication state of the parking lot management device 500 being restored.

Also, in the second control pattern, a state of communication with the parking lot management device 500 may not be normal or the parking lot management device 500 itself may be in an abnormal state after the automated entering instruction is received from the parking lot management device 500 and at a timing before the reception of the entering instruction route or a timing before the start of traveling along the entering instruction route. In this case, the autonomous parking controller 142 may perform control for curbing automated entering. Control for transmitting information indicating that the communication state of the parking lot management device 500 is not normal or information indicating that the parking lot management device 500 itself is in the abnormal state to the terminal device 300 may be performed.

### [Automated Leaving]

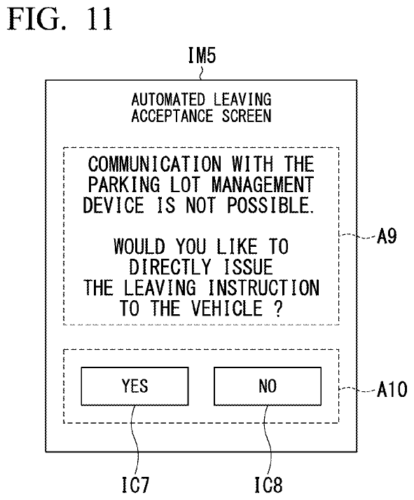

In the second control pattern, when the state of communication with the parking lot management device 500 is not normal or when the parking lot management device 500 itself is in the abnormal state at the time of leaving, the output controller 360 generates an image for inquiring about whether or not to directly issue a leaving instruction to the host vehicle M and causes the display 330 to display the generated image. FIG. 11 is a diagram showing an example of an image IM5 for inquiring about whether or not to directly issue a leaving instruction to the host vehicle M. In the example of FIG. 11, the image IM5 includes a text information display area A9 and a selection item display area A10. In the text information display area A9, for example, information indicating that communication with the parking lot management device is not possible and information for inquiring about whether or not to directly issue an automated leaving request to the host vehicle M instead of the parking lot management device 500 are displayed. In the example of FIG. 11, text information such as “Communication with the parking lot management device is not possible. Would you like to directly issue the leaving instruction to the vehicle?” is displayed in the text information display area A9.

The selection item display area A10 includes a GUI icon IC7 (a YES button) for accepting the approval for content displayed in the text information display area A9 and a GUI icon IC8 (a NO button) for accepting the disallowance for content displayed in the text information display area A9. When the input 320 has received the operation of the GUI icon IC7 by the user U, the output controller 360 transmits an automated leaving instruction to the host vehicle M and causes the display of the image IM5 to end. When the input 320 has received the operation of the GUI icon IC8 by the user U, the output controller 360 causes the display of the image IM5 to end.

Because the leaving instruction route cannot be received from the parking lot management device 500 when the automated leaving instruction has been received from the terminal device 300, the autonomous parking controller 142 executes the automated leaving for causing the host vehicle M to leave using the entry traveling trajectory information 194 stored in the storage 190. Specifically, the autonomous parking controller 142 generates a scheduled traveling route for causing the host vehicle M to travel so that an area of at least a part of the traveling trajectory TR1 from the point P2 to the point P1 is reversely reproduced by setting the end point P2 of the traveling trajectory TR1 included in the entry traveling trajectory information 194 as a start point at the time of leaving and setting the start point P1 as an end point at the time of leaving. Reverse reproduction includes, for example, leaving along the traveling route at the time of entering. The reverse reproduction may include performing the behavior at the time of leaving on the basis of the behavior of the host vehicle M at the time of entering (for example, the speed at the time of entering). Then, the autonomous parking controller 142 causes the host vehicle M to move to the stopping area 410 by causing the host vehicle M to travel on the basis of a target trajectory based on the generated scheduled traveling route.

Also, if the traveling of the host vehicle M at the time of entering is simply reversely reproduced, the host vehicle M is allowed to travel while moving backward. Accordingly, the autonomous parking controller 142 may generate a scheduled traveling route for causing the host vehicle M to leave in a direction opposite to the direction of the host vehicle M at the time of entering so that traveling of the reverse reproduction is enabled while the host vehicle M also moves forward at the time of leaving.

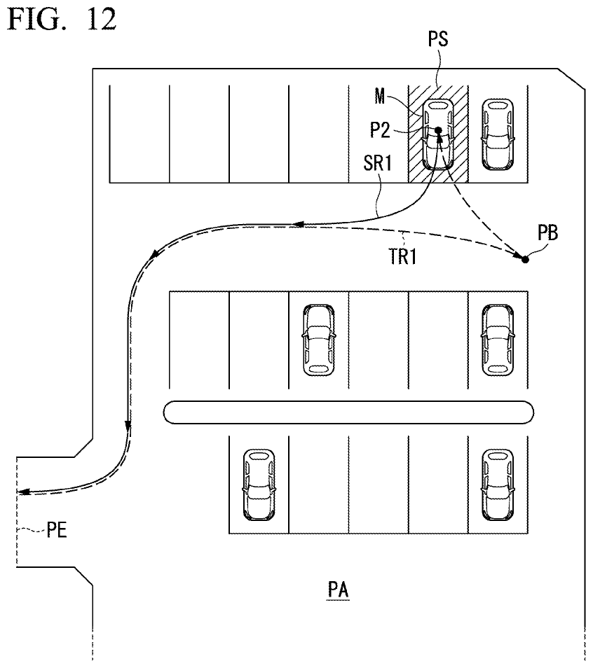

FIG. 12 is a diagram for describing generation of a scheduled traveling route in a direction opposite to a direction of the vehicle M when the vehicle M travels along the traveling trajectory at the time of entering. In the example of FIG. 12, a partial area including the traveling trajectory TR1 in the entire area of the parking lot PA is shown. In order to enable the vehicle to travel in the direction opposite to the direction at the time of entering, the autonomous parking controller 142 generates a scheduled traveling route SR1 for first rotating the steering from the current point P2 of the host vehicle M parked in the parking space PS in the traveling direction at the time of leaving to cause the host vehicle M to move forward and subsequently performing traveling along the traveling trajectory TR1. In the example of FIG. 12, the autonomous parking controller 142 generates a scheduled traveling route SR1 for turning the host vehicle M to the right so that the host vehicle M can move forward toward an exit point of the parking lot PA (a point PE shown in FIG. 12) and causing the host vehicle M to move forward while performing steering control so that the host vehicle M is within a predetermined distance from the point P2 and an amount of change in the steering angle is within a predetermined amount of change. The autonomous parking controller 142 generates the scheduled traveling route SR1 for causing the host vehicle M to travel along the traveling trajectory TR1 from a point overlapping the traveling trajectory TR1. Thereby, the autonomous parking controller 142 can make the traveling direction at the time of leaving opposite to the traveling direction at the time of entering with the smooth behavior of the host vehicle M and cause the host vehicle M to leave while moving forward to the exit PE of the parking lot PA.

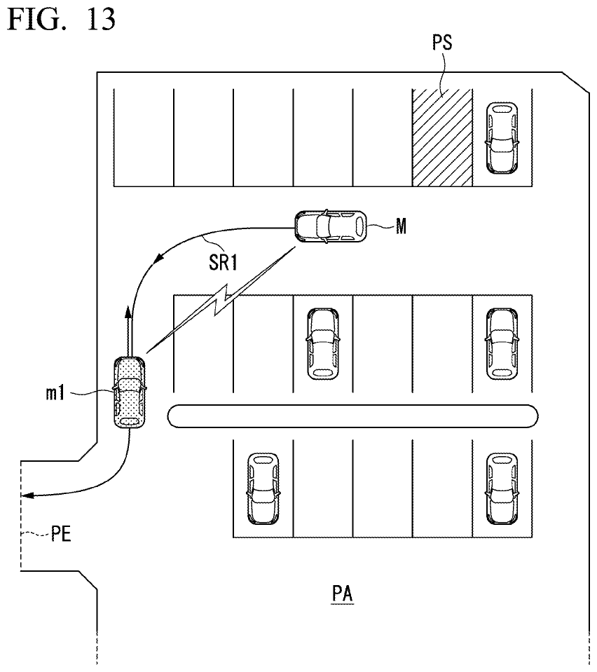

The autonomous parking controller 142 may perform inter-vehicle communication with another vehicle when the other vehicle recognized by the recognizer 130 is present at a position where the host vehicle M cannot travel along the scheduled traveling route SR1 and perform control for causing the other vehicle to move. FIG. 13 is a diagram showing an example of a scene in which another vehicle m1 is present on the scheduled traveling route SR1. In the example of FIG. 13, a scene in which the other vehicle m1 is present on the scheduled traveling route SR1 and is traveling in the direction opposite to the traveling direction of the host vehicle M is shown. In this scene, the host vehicle M cannot travel along the scheduled traveling route SR1 due to the presence of the other vehicle m1. Therefore, the autonomous parking controller 142 issues an instruction for performing inter-vehicle communication with the other vehicle m1 and causing the other vehicle m1 to move from the scheduled traveling route SR1 to a predetermined position so that the host vehicle M travels without departing from the scheduled traveling route SR1. The predetermined position is, for example, a position at which the host vehicle M can travel along the scheduled traveling route SR1 without being in contact with the other vehicle m1. For example, the autonomous parking controller 142 transmits information about the scheduled traveling route SR1 to the other vehicle m1 and issues an instruction for causing the other vehicle m1 to move to a position away from the scheduled traveling route SR1. The autonomous parking controller 142 may derive a movement destination position of the other vehicle m1 on the basis of the scheduled traveling route SR1 and the position of the other vehicle m1, transmit the derived position to the other vehicle m1, and cause the other vehicle m1 to move to the above-described position.

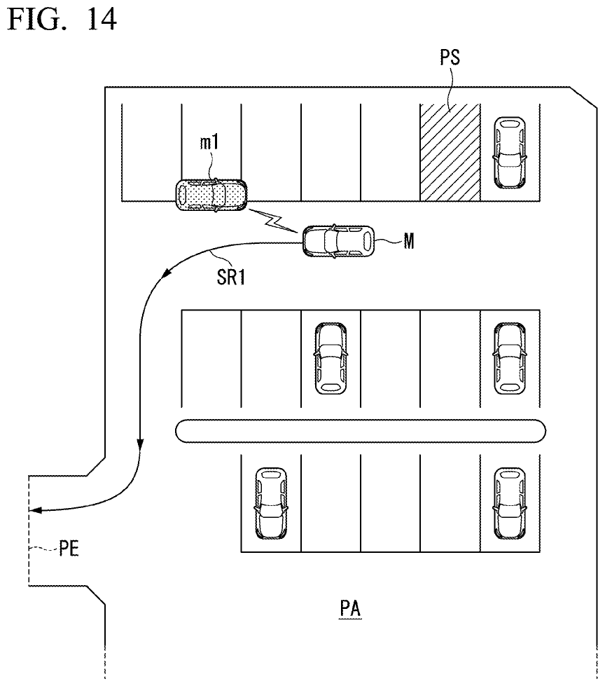

FIG. 14 is a diagram showing a scene after the other vehicle m1 is moved. The autonomous parking controller 142 causes the other vehicle m1 to be moved (evacuated) to a predetermined position as shown in FIG. 14 according to inter-vehicle communication with the other vehicle m1. The autonomous parking controller 142 may perform control for causing the host vehicle M to stop or decelerate while the other vehicle m1 is moving. In this manner, the autonomous parking controller 142 can cause the host vehicle M to travel while maintaining the scheduled traveling route SR1 by performing inter-vehicle communication to cause another vehicle to move when the other vehicle is present on the scheduled traveling route SR1 generated in correspondence with the traveling trajectory TR1 at the time of automated entering. The vehicle can leave along a route through which the vehicle passes at the time of entering, thereby traveling more safely within the parking lot PA without the guidance of the parking lot management device 500.

The autonomous parking controller 142 may perform inter-vehicle communication with another vehicle when the recognizer 130 recognizes the other vehicle whose leaving is in progress while the host vehicle M is leaving and may determine the vehicle to leave first. In this case, the autonomous parking controller 142 acquires information about the entering time and the scheduled traveling route of the other vehicle from the other vehicle whose leaving is in progress and determines the priority of leaving on the basis of the entering time of the other vehicle m1 (the entering time of the other vehicle) and the entering time of the host vehicle M (the entering time of the host vehicle) when the acquired scheduled traveling route is predicted to overlap a part of the scheduled traveling route SR1 of the host vehicle M.

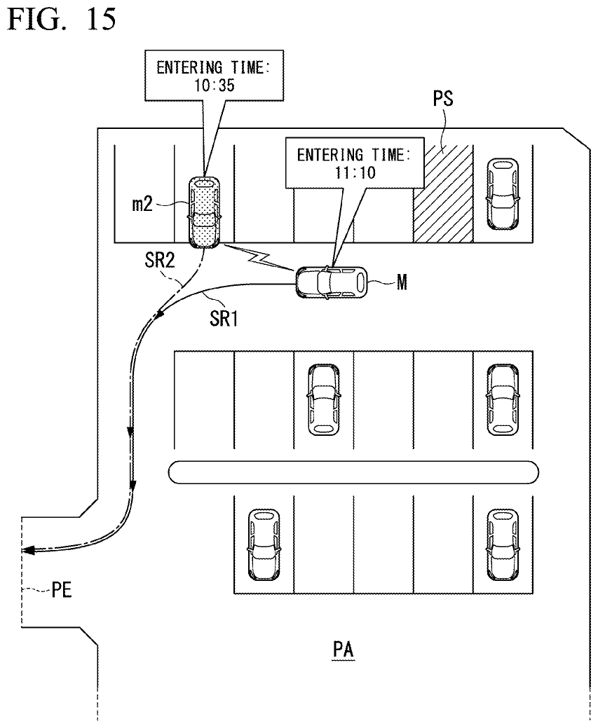

FIG. 15 is a diagram for describing driving control when the scheduled traveling route SR2 of the other vehicle m2 is predicted to overlap a part of the scheduled traveling route SR1 of the host vehicle M. In the example of FIG. 15, the autonomous parking controller 142 performs inter-vehicle communication with the other vehicle m2 when the other vehicle m2 whose leaving is in progress has been recognized from the behavior of the other vehicle m2 recognized by the recognizer 130 and acquires the scheduled traveling route SR2 of the other vehicle m2 and the entering time of the other vehicle.

Next, the autonomous parking controller 142 compares the scheduled traveling route SR2 with the scheduled traveling route SR1 of the host vehicle M and compares the entering time of the other vehicle with the entering time of the host vehicle when there is an overlapping route including time information (in other words, a route in which the contact is likely to occur when leaving of the two vehicles continues). Then, the autonomous parking controller 142 determines the priority so that, for example, the vehicle with the earlier time (the vehicle that has entered earlier) leaves first. The autonomous parking controller 142 may determine the priority so that the vehicle at a shorter distance to the exit (for example, the point PE) leaves first in place of (or in addition to) the above-described entering time.

In the example of FIG. 15, the entering time of the host vehicle M is “11:10” and the entering time of another vehicle m2 is “10:35” on the day that is the same as that of the time of entering of the host vehicle M. Therefore, the autonomous parking controller 142 generates an action plan for causing the host vehicle M to stop or decelerate on the scheduled traveling route SR1 so that the other vehicle m2 is allowed to leave first. The autonomous parking controller 142 performs control for transmitting information about the priority to the other vehicle m2 and causing the other vehicle m2 to leave first. Thereby, it is possible to cause vehicles to smoothly leave even if parts of scheduled traveling routes of the host vehicle M and the other vehicle m2 overlap. When the recognizer 130 has recognized a physical object such as an obstacle at a position where the host vehicle M cannot travel along the scheduled traveling route SR1, the autonomous parking controller 142 may generate an avoidance route for allowing the host vehicle M to travel while avoiding the contact with the physical object on the basis of the scheduled traveling route SR1 and cause the host vehicle M to travel along the generated avoidance route.

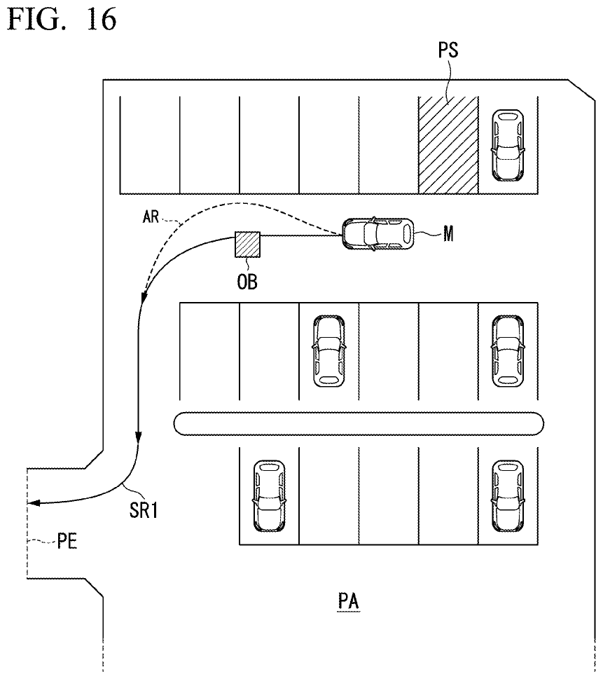

FIG. 16 is a diagram for describing driving control when there is an obstacle OB on the scheduled traveling route SR1. In the example of FIG. 16, an example in which the obstacle OB is present on the scheduled traveling route SR1 is shown. In this case, the autonomous parking controller 142 generates an avoidance route AR offset by a distance at which a vehicle can travel while avoiding the obstacle OB on the basis of the scheduled traveling route SR1. In this case, for example, the autonomous parking controller 142 generates the avoidance route AR so that a distance or an amount of offset (an amount of lateral displacement with respect to the scheduled traveling route SR1) of the avoidance route AR is minimized Thereby, it is possible to cause the host vehicle M to leave even if the obstacle OB is present on the scheduled traveling route SR1. The host vehicle M is allowed to travel along the avoidance route AR in which deviation from the scheduled traveling route SR1 is curbed, so that a change from the behavior during traveling along the traveling trajectory TR1 at the time of entering is reduced and the host vehicle M can be allowed to leave with safer behavior.

Although the leaving control from the parking space PS to the exit (the point PE) of the parking lot PA has been mainly described in the automated leaving process in the second control pattern, there is a possibility that the vehicle will reversely travel from the exit (the point PE) of the parking lot PA to the point P1 of the stopping area 410. Therefore, the autonomous parking controller 142 may determine whether or not a section in which the vehicle reversely travels on the road is included in at least a part of the scheduled traveling route SR1 in which the traveling trajectory TR1 is reversely reproduced on the basis of the parking lot map information 532 stored in the storage 530 of the parking lot management device 500 at the time of entering and generate a scheduled traveling route on the basis of a determination result. For example, when it is determined that the vehicle reversely travels on a road in a part of the scheduled traveling route SR1 (for example, from the point PE to the point P1) in which the traveling trajectory TR1 is reversely reproduced, the autonomous parking controller 142 reproduces a scheduled traveling route in which there is no reverse traveling on the basis of map information from the point PE to the point P1 and causes the host vehicle M to travel along the reproduced scheduled traveling route. In this manner, it is possible to execute more appropriate automated leaving by determining whether or not the vehicle can travel along the scheduled traveling route in which the traveling trajectory is reversely reproduced on the basis of the map information.

[Process of Parking Lot Management Device 500 when Communication State is Restored]

Next, a process of the parking lot management device 500 when the communication state has been restored will be described. The parking situation manager 524 of the parking lot management device 500 manages a parking situation of a vehicle allowed to enter and leave each parking space of the parking lot PA. Here, when the communication state manager 522 determines that the communication state is abnormal, the parking situation manager 524 cannot manage the leaving situation or the entering situation of the vehicle with respect to each parking space of the parking lot PA and the parking space state table 534 is not updated. Therefore, the parking situation manager 524 updates the parking space state table 534 stored in the storage 530 when the communication state manager 522 recognizes that the communication state has been changed (restored) from the abnormal state to the normal state.

In this case, the parking situation manager 524 communicates with a vehicle present within the parking lot PA via the communicator 510 and inquires about the parking situation. The parking situation to be inquired about includes, for example, information such as a position information and a vehicle ID of a vehicle, a situation of the vehicle, an entering time, a scheduled leaving time, and the like. The situation of the vehicle includes, for example, information about a situation such as a situation in which parking is in progress, a situation in which entering is in progress, or a situation in which leaving is in progress. The parking situation manager 524 stores an inquiry result obtained from each vehicle in the storage 530 as the parking situation inquiry result 536.

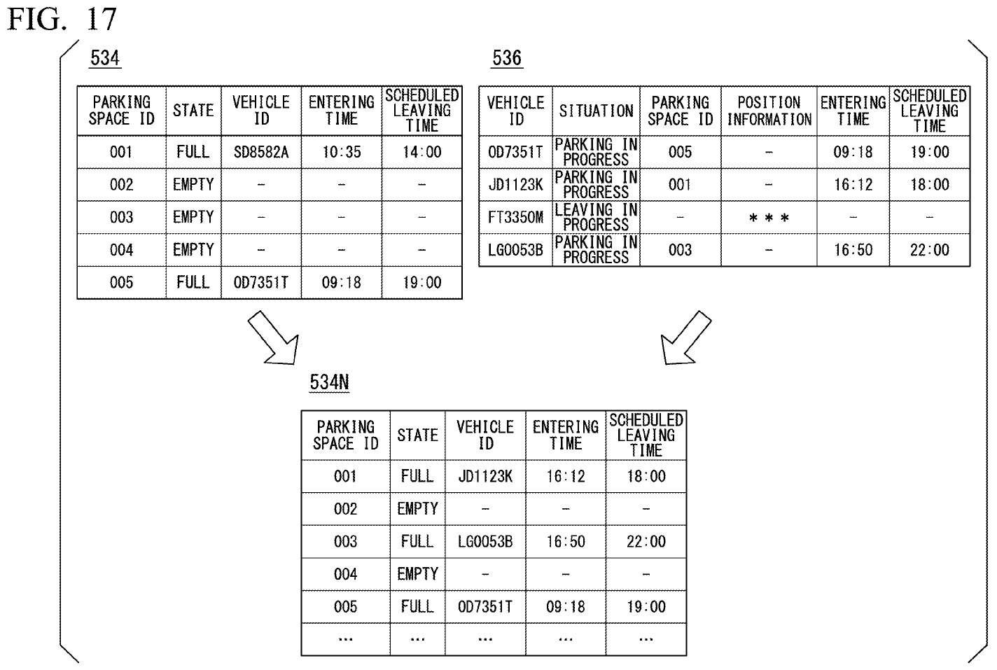

Next, the parking situation manager 524 updates the parking space state table 534 stored in the storage 530 on the basis of the parking situation inquiry result 536. FIG. 17 is a diagram for describing updating of the parking space state table 534. In the example of FIG. 17, the parking space state table 534, the parking situation inquiry result 536, and an updated parking space state table 534N are shown.

In the parking situation inquiry result 536, the situation of the vehicle, the parking space ID, the position information, the entering time, and the scheduled leaving time are associated with the vehicle ID. For example, when the situation of the vehicle is a situation in which parking is in progress, information corresponding to the “parking space ID”, the “entering time”, and the “scheduled leaving time” is stored in addition to the “vehicle ID” and the “situation”. When the situation of the vehicle is a situation in which entering or leaving is in progress, information corresponding to the “position information” is stored in addition to the “vehicle ID” and the “situation”.

The parking situation manager 524 performs matching between the parking space IDs of the parking space state table 534 and the parking situation inquiry result 536 and updates information of the “state”, the “vehicle ID”, the “entering time”, and the “scheduled leaving time” corresponding to the corresponding parking space ID of the parking space state table 534 on the basis of information of the “vehicle ID”, the “situation”, the “entering time”, and the “scheduled leaving time” stored in the parking situation inquiry result 536 when the matched parking space ID is present. When information is stored in the parking space ID of the parking situation inquiry result 536, the situation of the vehicle is a situation in which parking is in progress. Thus, the parking situation manager 524 sets information indicating the full state (for example, “full”) in the “state” associated with the parking space ID of the parking space state table 534.

In the example of FIG. 17, information of parking space IDs “001” and “003” is updated in the updated parking space state table 534N. Thereby, the parking lot management device 500 can appropriately perform the entering control or the leaving control of the vehicle after the communication state is restored using the updated parking space state table 534N.

When the “situation” of the parking situation inquiry result 536 includes a situation of a vehicle whose “entering” or “leaving” is in progress, the vehicle is traveling without being guided by the parking lot management device 500. Therefore, the entering/leaving controller 526 performs control so that an automated entering instruction or an automated leaving instruction is not transmitted to a target vehicle even if an automated entering or leaving request of another vehicle has been received from the terminal device before the entering or leaving of the vehicle is completed when there is a vehicle whose entering or leaving is in progress on the basis of the parking situation inquiry result 536. Thereby, it is possible to curb contact between the vehicle that is not traveling according to the guidance of the parking lot management device 500 and the vehicle that is traveling according to the guidance and consequently it is possible to perform smoother entering and leaving control.

Although automated entering and automated leaving when the communication state of the parking lot management device 500 is not normal have been described in the above-described second control pattern, it is possible to perform a process similar to the above-described process with respect to automated entering and automated leaving when the parking lot management device 500 itself is in an abnormal state. In this case, the autonomous parking controller 142 executes the second control pattern when the communication device 20 has received information indicating that the communication state of the parking lot management device 500 is not normal.

In the second control pattern, for example, when the communication state of the terminal device 300 is not normal, an automated entering request or an automated leaving request cannot be transmitted to the parking lot management device 500 or an automated entering instruction or an automated leaving instruction cannot be transmitted to the host vehicle M. When the communication state of the host vehicle M is abnormal, it is not possible to receive an automated entering instruction or an automated leaving instruction from the parking lot management device 500 or the terminal device 300, so that automated entering or automated leaving cannot be executed.

### [Process Flow]

Next, a flow of a process to be executed by the vehicle system 1 and the like of the embodiment will be described with reference to a flowchart. In the following, a process to be executed by the terminal device 300, an automated entering process and an autonomous leaving process to be executed by the automated driving controller 100, and a process to be executed by the parking lot management device 500 after the communication state is restored will be described separately.

### [Process to be Executed by Terminal Device 300]

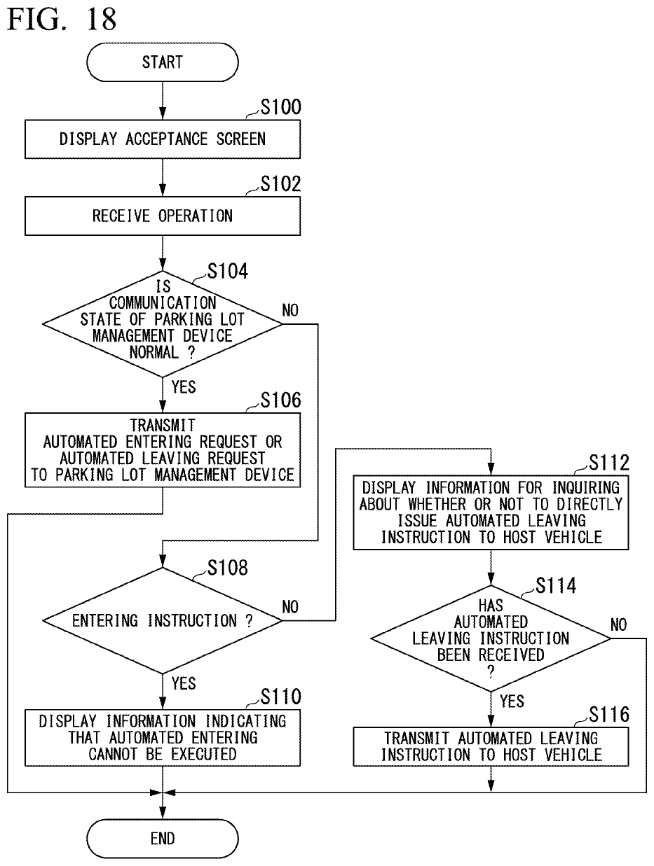

FIG. 18 is a flowchart showing an example of a flow of a process to be executed by the terminal device 300 according to the embodiment. In the example of FIG. 18, the output controller 360 causes an acceptance screen (for example, the image IM1 or the image IM3) for accepting automated entering or leaving to be displayed at a predetermined timing (step S100). Next, the input 320 receives an operation from the user U (step S102). In the processing of step S102, the input 320 may receive an input of a scheduled leaving time from the user U. Next, the application executor 350 determines whether or not the communication state of the parking lot management device 500 is normal (step S104). When it is determined that the communication state is normal, the application executor 350 transmits the received automated entering request or automated leaving request to the parking lot management device 500 together with a vehicle ID of a target vehicle (step S106).

When it is determined that the communication state of the parking lot management device 500 is not normal in the processing of step S104, the application executor 350 determines whether or not received operation content is an entering instruction (step S108). When it is determined that the received operation content is an entering instruction, the output controller 360 causes the display 330 to display information (for example, the image IM4) indicating that automated entering cannot be performed (step S110).

When it is determined that the received operation content is not an entering instruction in the processing of step S108, it is determined that the received operation content is a leaving instruction. In this case, the output controller 360 causes the display 330 to display information (for example, the image IM5) for inquiring about whether or not to directly issue an automated leaving instruction to the host vehicle M (step S112). Next, the input 320 determines whether or not an automated leaving instruction has been received (step S114). When it is determined that the automated leaving instruction has been received, the application executor 350 transmits the automated leaving instruction to the host vehicle M via the communicator 310 (step S116). Thereby, the process of the present flowchart ends. When it is determined that the automated leaving instruction has not been received in the processing of step S114, the process of the present flowchart ends. In the processing of step S104 of the present flowchart, instead of determining whether or not the communication state of the parking lot management device 500 is normal, it may be determined whether or not the communicator 310 has received information indicating the abnormal state transmitted from the parking lot management device 500. In this case, the application executor 350 executes the processing of step S106 when it is determined that the information indicating the abnormal state has not been received and executes the processing from step S108 when it is determined that the information indicating the abnormal state has been received.

### [Automated Entering Process to be Executed by Automated Driving Controller 100]

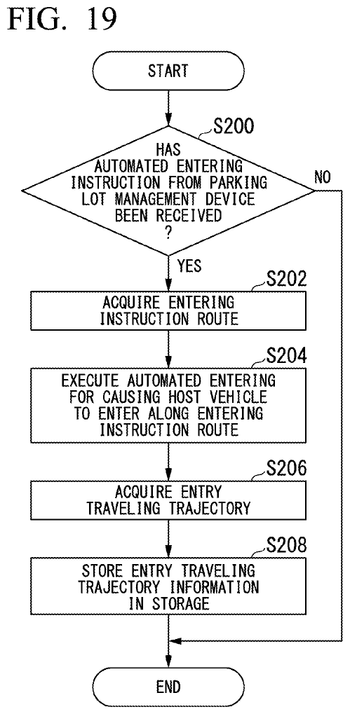

FIG. 19 is a flowchart showing an example of a flow of an automated entering process to be executed by the automated driving controller 100 according to the embodiment. In the example of FIG. 19, the automated driving controller 100 determines whether or not the communication device 20 has received an automated entering instruction from the parking lot management device 500 (step S200). When it is determined that the automated entering instruction has been received from the parking lot management device 500, the autonomous parking controller 142 acquires an entering instruction route from the parking lot management device 500 (step S202) and executes the automated entering for causing the host vehicle M to enter a predetermined parking space along the acquired entering instruction route (step S204). Next, the traveling trajectory recognizer 134 acquires an entry traveling trajectory when the vehicle is parked in a predetermined parking space (step S206) and stores the information about the acquired entry traveling trajectory (entry traveling trajectory information) in the storage 190 (step S208). Thereby, the process of the present flowchart ends. When it is determined that the automated entering instruction has not been received in the processing of step S200, the process of the present flowchart ends.

### [Automated Leaving Process to be Executed by Automated Driving Controller 100]

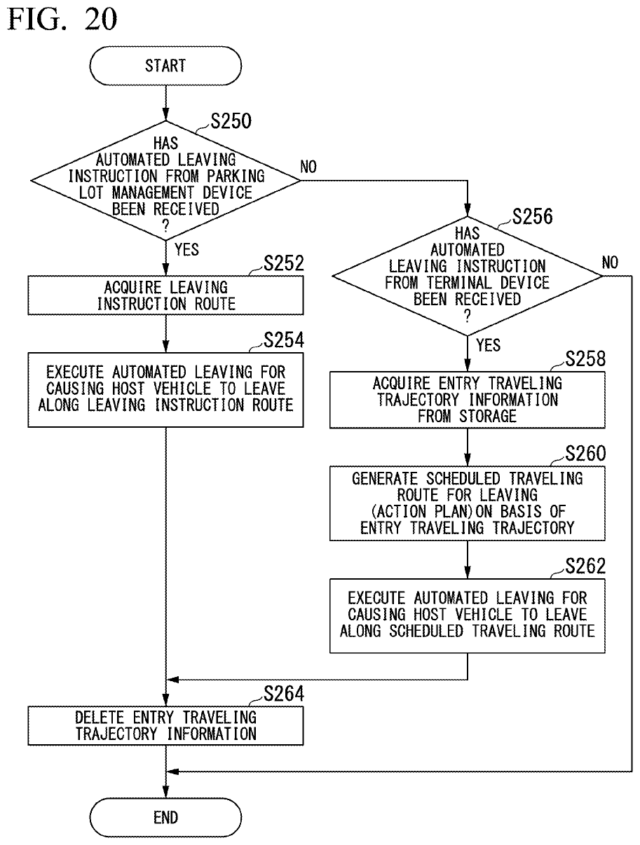

FIG. 20 is a flowchart showing an example of a flow of the automated leaving process to be executed by the automated driving controller 100 according to the embodiment. In the example of FIG. 20, the automated driving controller 100 determines whether or not the communication device 20 has received an automated leaving instruction from the parking lot management device 500 (step S250). When it is determined that the automated leaving instruction has been received, the autonomous parking controller 142 acquires a leaving instruction route from the parking lot management device 500 (step S252) and causes the host vehicle M to execute automated leaving along the acquired leaving instruction route (step S254).

When it is determined that the automated leaving instruction from the parking lot management device 500 has not been received in the processing of step S250, the automated driving controller 100 determines whether or not the communication device 20 has received the automated leaving instruction from the terminal device 300 (step S256). A case in which the automated leaving instruction from the terminal device 300 is received is a case in which the state of communication with the parking lot management device 500 is not normal (abnormal) or a case in which the parking lot management device 500 itself is in an abnormal state. When it is determined that the automated leaving instruction from the terminal device 300 has been received, the autonomous parking controller 142 acquires the entry traveling trajectory information from the storage 190 (step S258) and generates a scheduled traveling route (an action plan) for leaving on the basis of the acquired entry traveling trajectory (step S260). Next, the autonomous parking controller 142 executes automated leaving for causing the host vehicle M to leave along the scheduled traveling route (step S262).

Next, after the processing of step S254 or step S262 is completed, the autonomous parking controller 142 deletes the entry traveling trajectory information 194 stored in the storage 190 (step S264). Thereby, the process of the present flowchart ends. When it is determined that the automated leaving instruction from the terminal device 300 has not been received in the processing of step S256, the process of the present flowchart ends. In the processing of step S264, the autonomous parking controller 142 may use the entry traveling trajectory information 194 at the next time of entering or leaving in the same parking lot without deleting the entry traveling trajectory information 194 after leaving is completed.

[Process after Communication State is Restored to be Executed by Parking Lot Management Device 500]

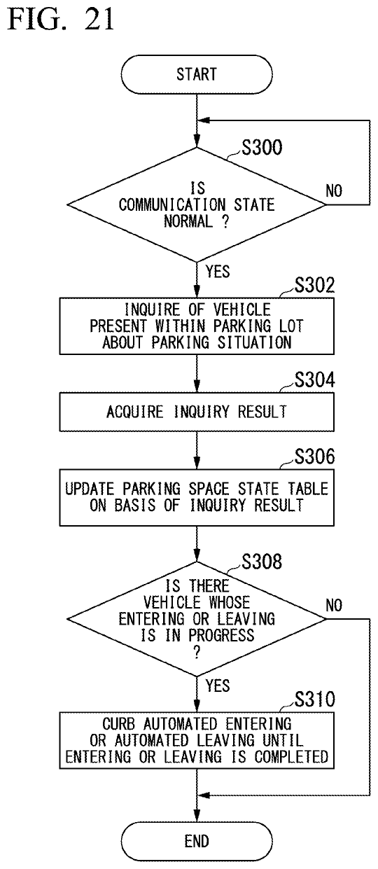

FIG. 21 is a flowchart showing an example of a flow of a process to be executed by the parking lot management device 500 after the communication state is restored. In the example of FIG. 21, the communication state manager 522 determines whether or not the communication state of the parking lot management device 500 is normal (step S300). The parking situation manager 524 waits until the communication state is determined to be normal by the communication state manager 522 and sends an inquiry about the parking situation to a vehicle present within the parking lot PA when the communication state is determined to be normal (step S302). Next, the parking situation manager 524 acquires a parking situation inquiry result from the vehicle present within the parking lot PA (step S304) and updates the parking space state table 534 stored in the storage 530 on the basis of the acquired inquiry result (the parking situation inquiry result 536) (step S306).

Next, the entering/leaving controller 526 determines whether or not there is a vehicle whose entering or leaving is in progress in the inquiry result (step S308). When there is a vehicle whose entering or leaving is in progress, automated entering or leaving of another vehicle is curbed until entering or leaving of the vehicle is completed (step S310). When it is determined that there is no vehicle whose entering or leaving is in progress after the processing of step S308 or in the processing of step S308, the process of the present flowchart ends. In the processing of step S300 of the present flowchart, the communication state manager 522 determines whether or not the parking lot management device 500 is in an abnormal state instead of determining whether or not the communication state of the parking lot management device 500 is normal. In this case, after information indicating the abnormal state is transmitted to the terminal device 300 or the vehicle when it is determined that the parking lot management device 500 is in an abnormal state, the communication state manager 522 waits until it is determined that the parking lot management device 500 is not in an abnormal state.

According to the embodiment described above, the automated driving controller 100 includes the recognizer 130 configured to recognize a surrounding environment of the host vehicle M; and a driving controller (the action plan generator 140 and the second controller 160) configured to perform driving control of one or both of a speed and steering of the host vehicle M on the basis of a recognition result of the recognizer 130, wherein the driving controller stores a traveling trajectory until the host vehicle M enters a parking place in the storage 190, generates a scheduled traveling route for leaving using the traveling trajectory stored in the storage 190 when the host vehicle M leaves the parking place, and causes the host vehicle M to travel on the basis of the generated scheduled traveling route, so that it is possible to execute more appropriate driving control in a situation in which a vehicle travels in an area including a parking lot.

According to the embodiment, for example, even if the communication state between the host vehicle M and the parking lot management device 500 is abnormal (not normal), it is possible to perform safer leaving control without requiring guidance of the parking lot management device 500 because the host vehicle M can leave along a traveling trajectory at the time of entering.

### [Hardware Configuration]

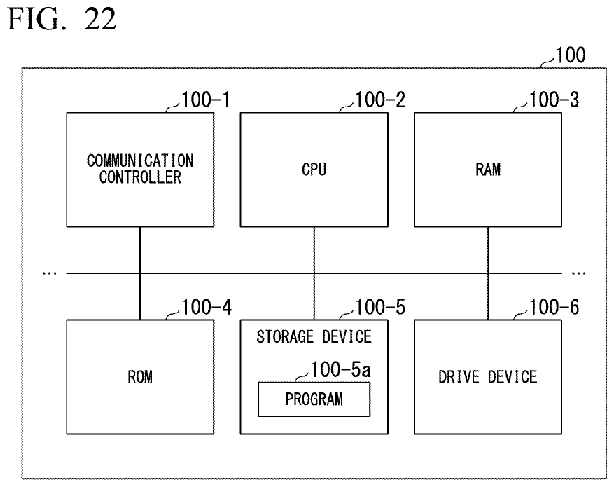

FIG. 22 is a diagram showing an example of a hardware configuration of the automated driving controller 100 according to the embodiment. As shown in FIG. 22, a computer of the automated driving controller 100 has a configuration in which a communication controller 100-1, a CPU 100-2, a RAM 100-3 used as a working memory, a ROM 100-4 storing a boot program and the like, a storage device 100-5 such as a flash memory or a HDD, a drive device 100-6, and the like are mutually connected by an internal bus or a dedicated communication line. The communication controller 100-1 communicates with components other than the automated driving controller 100. A portable storage medium such as an optical disk (for example, a computer-readable non-transitory storage medium) is mounted on the drive device 100-6. The storage device 100-5 stores a program 100-5a to be executed by the CPU 100-2. This program is loaded into the RAM 100-3 by a direct memory access (DMA) controller (not shown) or the like and executed by the CPU 100-2. The program 100-5a referred to by the CPU 100-2 may be stored in a portable storage medium mounted on the drive device 100-6 or may be downloaded from another device via a network. Thereby, some or all of the components of the automated driving controller 100 are implemented.

Also, the above-described hardware configuration described above can also be applied as an example of the hardware configuration of the parking lot management device 500 of the embodiment. In this case, the computer of the parking lot management device 500 includes a configuration in which a communication controller 100-1, a CPU 100-2, a RAM 100-3 used as a working memory, a ROM 100-4 storing a boot program and the like, and a storage device 100-5 such as a flash memory or an HDD, a drive device 100-6, and the like are interconnected by an internal bus or a dedicated communication line. Thereby, some or all of the components of the parking lot management device 500 are implemented.

The embodiment described above can be represented as follows.

A vehicle control device including:

a storage device storing a program; and

a hardware processor,

wherein the hardware processor executes the program stored in the storage device to:

recognize a surrounding environment of a host vehicle;

perform driving control of one or both of a speed and steering of the host vehicle on the basis of a recognition result;

store a traveling trajectory until the host vehicle enters a parking place in a storage;

generate a scheduled traveling route for leaving using the traveling trajectory when the host vehicle leaves the parking place; and

cause the host vehicle to travel on the basis of the generated scheduled traveling route.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a processor;
a memory storing program instructions executable by the processor to:
recognize a surrounding environment of a host vehicle; and
perform driving control of one or both of a speed and steering of the host vehicle on the basis of a recognition result of the recognizer,
wherein performing driving control comprises storing a traveling trajectory until the host vehicle enters a parking place in a storage, generating a scheduled traveling route for leaving using the traveling trajectory when the host vehicle leaves the parking place, and causing the host vehicle to travel on the basis of the generated scheduled traveling route.

2. The vehicle control device according to claim 1, wherein the program instructions are further executable by the processor to:
communicate with a terminal device and a parking lot management device for managing a parking lot including the parking place,
wherein performing driving control comprises generating a traveling route for leaving using the traveling trajectory when communication with the parking lot management device is not normal or when receiving information indicating an abnormal state transmitted from the parking lot management device and a leaving instruction from the terminal device has been received and causing the host vehicle to travel on the basis of the generated traveling route.

3. The vehicle control device according to claim 1, wherein generating the scheduled traveling route comprises generating a scheduled traveling route for causing the host vehicle to travel along the traveling trajectory in a reverse direction.

4. The vehicle control device according to claim 2, wherein performing driving control comprises when another vehicle is present at a position where the host vehicle cannot travel along the scheduled traveling route, performing communication with the other vehicle and causing the other vehicle to move to a position where the host vehicle can travel along the scheduled traveling route.

5. The vehicle control device according to claim 2, wherein performing driving control comprises acquiring a scheduled traveling route and an entering time of another vehicle whose leaving is in progress, comparing the entering time of the other vehicle with an entering time of the host vehicle when the acquired scheduled traveling route overlaps at least a part of the scheduled traveling route of the host vehicle, and causing the vehicle whose entering time is earlier to preferentially leave.

6. The vehicle control device according to claim 1, wherein performing driving control comprises when a physical object at a position where the host vehicle cannot travel along the scheduled traveling route, generating an avoidance route along which the host vehicle will travel while avoiding contact with the physical object on the basis of the scheduled traveling route and causing the host vehicle to travel along the generated avoidance route.

7. The vehicle control device according to claim 2, wherein performing driving control comprises when communication with the parking lot management device is not normal or when the processor has acquired information indicating an abnormal state transmitted from the parking lot management device, curbing driving control for entry to the parking place.

8. A terminal device for communicating with the vehicle control device according to claim 1, the terminal device comprising:
a processor;
a memory storing program instructions executable by the processor to:
communicate with the vehicle control device and a parking lot management device for managing a parking lot including the parking place where vehicles are parked; and
output an entering request or a leaving request of the host vehicle to the parking lot management device when a state of communication with the parking lot management device is normal and output a leaving request of the host vehicle to the vehicle control device when the state of communication with the parking lot management device is not normal or when the processor has acquired information indicating an abnormal state transmitted from the parking lot management device and communication with the vehicle control device is enabled.

9. The terminal device according to claim 8, wherein outputting driving control comprises the entering request or the leaving request comprises doing not output the leaving request of the host vehicle to the vehicle control device when the state of communication with the parking lot management device is not normal or when the processor has acquired information indicating the abnormal state transmitted from the parking lot management device and the communication with the vehicle control device is normal.

10. A parking lot management device for communicating with the vehicle control device according to claim 1 and managing a parking lot including the parking place where vehicles are parked, the parking lot management device comprising:
a processor;
a memory storing program instructions executable by the processor to:
communicate with the vehicle control device and a terminal device; and
control entering or leaving of a vehicle for each parking place of the parking lot,
wherein controlling entering or leaving of the vehicle comprises inquiring of a vehicle present in the parking lot about a parking situation when a state of communication with the vehicle control device and the terminal device has changed from an abnormal state to a normal state and managing the parking situation of the parking lot on the basis of an inquiry result.

11. The parking lot management device according to claim 10, wherein controlling entering or leaving of the vehicle comprises curbing control of entering or leaving of another vehicle until the entering or leaving of the vehicle whose entering or leaving is in progress is completed when the vehicle whose entering or leaving is in progress is included in the inquiry result.

12. A vehicle control method comprising:
recognizing, by a computer, a surrounding environment of a host vehicle;
performing, by the computer, driving control of one or both of a speed and steering of the host vehicle on the basis of a recognition result;
storing, by the computer, a traveling trajectory until the host vehicle enters a parking place in a storage;
generating, by the computer, a scheduled traveling route for leaving using the traveling trajectory when the host vehicle leaves the parking place; and
causing, by the computer, the host vehicle to travel on the basis of the generated scheduled traveling route.

13. A computer-readable non-transitory storage medium storing a program for causing a computer to:
recognize a surrounding environment of a host vehicle;
perform driving control of one or both of a speed and steering of the host vehicle on the basis of a recognition result;
store a traveling trajectory until the host vehicle enters a parking place in a storage;
generate a scheduled traveling route for leaving using the traveling trajectory when the host vehicle leaves the parking place; and
cause the host vehicle to travel on the basis of the generated scheduled traveling route.
